(19) United States
(12) Patent Application Publication
(10) Pub. No.: US 2007/0208816 A1
(43) Pub. Date: Sep. 6, 2007

(54) System and method for electronically facilitating, recording, and tracking transactions

(75) Inventors: Michael Scott Baldwin, Rockville, MD (US); Kenneth Hansen, Centreville, VA (US); David H. Potter, N. Plainfield, NJ (US); Anthony Sorace, Rockville, MD (US); Paul C. Lustgarten, Westfield, NJ (US); Uriel W. Orellana, Rockville, MD (US)

Correspondence Address: STERNE, KESSLER, GOLDSTEIN & FOX P.L.L.C., 1100 NEW YORK AVENUE, N.W., WASHINGTON, DC, 20005, US

(73) Assignee: Cibernet Corporation, Bethesda, MD (US)

(21) Appl. No.: 11/701,532

(22) Filed: Feb. 2, 2007

Related U.S. Application Data
(60) Provisional application No. 60/764,610, filed on Feb. 3, 2006.

(51) Int. Cl. G06F 15/16

(52) U.S. Cl. 709/206

(57) ABSTRACT

A method to facilitate a transaction using an instant messaging client comprising, receiving a formatted transaction request from the client via a messaging protocol, identifying a recipient and transaction information, facilitating the transaction and sending a notification of completion of the transaction via the messaging protocol.

### CROSS-REFERENCE TO RELATED APPLICATION

This application claims the benefit of U.S. Provisional Application No. 60/764,610, filed Feb. 3, 2006, which is incorporated herein by reference in its entirety.

### FIELD OF THE INVENTION

The present invention generally relates to electronic commerce.

### BACKGROUND

Instant messaging and Short Message Service (SMS) are common means of communication. Instant messaging involves exchanging messages between two or more people or entities.

SMS is a text message service that enables short messages of generally no more than 140-160 characters in length to be sent and transmitted from a cellular phone. SMS was introduced in the Global System for Mobile Communications (GSM) and later supported by other digital-based mobile communications systems. Unlike paging, but similar to e-mail, short messages are stored and forwarded at SMS centers. Messages can be retrieved later if a user is not immediately available to receive them. SMS messages travel to a cellular phone over a system's control channel, which is separate and apart from the voice channel.

Instant messaging typically utilizes an address book or a “buddy list”, which is a list of contacts in order to send an instant message. However, SMS and instant messaging services only provide for passing direct messages between users and are unable to facilitate a transaction using the SMS or instant messaging system.

What is needed are methods and systems to enable transactions via instant messaging.

### BRIEF DESCRIPTION OF DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 illustrates an exemplary operating environment for facilitating, recording, and/or tracking financial transactions according to an embodiment of the present invention.

FIG. 2 depicts exemplary records stored in an account database.

FIGS. 3A-B depict a flowchart of a method for facilitating, recording, and/or tracking financial transactions according to an embodiment of the present invention.

FIG. 4A depicts a flowchart of a method for entering transaction information into an end-user device having an IM client with an integrated instant money application, according to an embodiment of the present invention.

FIG. 4B depicts a flowchart of a method for entering transaction information into an end-user device having a separate instant money client, according to an embodiment of the present invention.

FIG. 4C depicts a flowchart of a method for initiating a transaction service via an electronic communications mechanism, according to an embodiment of the present invention.

FIG. 4D depicts a flowchart of a method for initiating a transaction service via a call center, according to an embodiment of the present invention.

FIG. 5 depicts an IM interface including a loan entry according to an embodiment of the present invention.

FIG. 6 depicts an exemplary instant money interface according to an embodiment of the present invention.

FIG. 7 depicts an exemplary GUI according to an embodiment of the present invention.

FIG. 8 depicts exemplary IM interfaces including indications of the payment transaction according to an embodiment of the present invention.

FIG. 9 depicts a flowchart of a method for facilitating, recording, and/or tracking financial transactions among individuals, according to an embodiment of the present invention.

FIG. 10 depicts an exemplary instant money payment pool interface according to an embodiment of the present invention.

FIG. 11 depicts a flowchart of a method for facilitating, recording, and/or tracking loan payments, according to an embodiment of the present invention.

FIG. 12 depicts a flowchart of a method for recording and/or tracking voucher transactions, according to an embodiment of the present invention.

FIG. 13 depicts exemplary fields in a voucher sub-account according to an embodiment of the present invention.

FIG. 14 depicts a flowchart of a method for recording and/or tracking charitable contributions or other documentation for tax purposes, according to an embodiment of the present invention.

FIG. 15A illustrates a high-level block diagram of an exemplary system for facilitating transactions, using a messaging protocol according to an embodiment of the present invention.

FIG. 15B illustrates a high-level block diagram of an exemplary system for facilitating financial transactions, according to an embodiment of the present invention.

FIG. 15C illustrates a high level block diagram of an exemplary system including a proxy for facilitating transactions, according to an embodiment of the present invention.

FIG. 15D illustrates a high level block diagram of an exemplary system including a proxy integrated with a server for facilitating transactions, according to an embodiment of the present invention.

FIG. 15E illustrates a high level block diagram of an exemplary system including a proxy integrated with a client for facilitating transactions, according to an embodiment of the present invention.

FIG. 16 illustrates an example flowchart showing steps performed from the perspective of a client for facilitating a transaction according to an embodiment of the present invention.

FIG. 17 illustrates an example flowchart showing steps performed from the perspective of an interface according to an embodiment of the present invention.

FIG. 18 illustrates an example flowchart showing steps performed from the perspective of an intermediary server according to an embodiment of the present invention.

FIG. 19 illustrates an example flowchart showing steps performed by a system using a messaging client to initiate and facilitate transactions according to an embodiment of the present invention.

FIG. 20 illustrates an example flowchart showing steps performed from the perspective of a proxy receiving messages from a client according to an embodiment of the invention.

FIG. 21 illustrates an example flowchart showing steps performed from the perspective of a proxy receiving messages from a server according to an embodiment of the invention.

FIG. 22 illustrates a block diagram of a computer system on which the present invention can be implemented.

The present invention is described with reference to the accompanying drawings. The drawing in which an element first appears is typically indicated by the leftmost digit or digits in the corresponding reference number.

### DETAILED DESCRIPTION OF THE INVENTION

The instant money application, described herein, uses instant messaging functionality and/or “buddy list” or “contact list” functionality for the purpose of initiating the transfer of funds, request for funds, or for the purpose of recording a transaction in which a debit or credit transaction of any type occurs.

### 1. ARCHITECTURE OVERVIEW

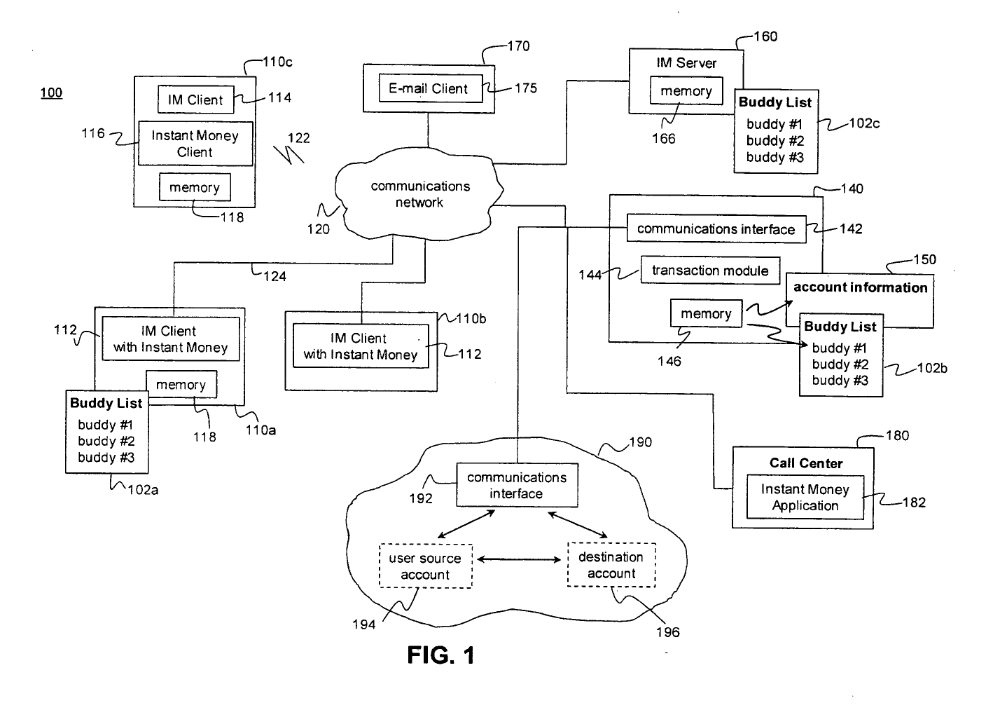

FIG. 1 illustrates an exemplary operating environment 100 for facilitating, recording, and/or tracking financial transactions among peers, according to an embodiment of the present invention. Exemplary operating environment 100 includes one or more user devices 110a-c, a communications network 120, an instant money server 140, and an optional financial/banking network 190. Operating environment 100 may also include an instant messaging (IM) server 160, user devices 170, and/or a call center 180.

User devices 110a-c communicate with the instant money server 140 and/or IM server 160 via communications network 120. Communications network 120 may be a public data communications network such as the Internet, a private data communications network, the Public Switched Telephone Network (PSTN), a signaling network, a wireless communications network, or any combination thereof. The interface between devices 110 a-c and communications network 120 can be a wireless interface 122 or a wired interface 124.

User device 110 can be any device capable of initiating and receiving electronic communications. Devices 110 may be any type of wired or wireless communication device including, but not limited to, a computer, a laptop, a personal digital assistant (PDA), personal media player, a wireless telephone, a wired telephone, and televisions.

In an embodiment, a user device (e.g., user device 110a) includes an IM client having an instant money application 112. An IM client is any program that displays a user list (e.g., “buddy list,” “contact list,” “address list,” etc.) and can initiate functions such as real-time or non real-time text or voice chats, phone calls, video conferences, e-mail, or similar. Although the term IM is used throughout, a person of skill in the art will recognize that any client software having similar functionality can be used with the present invention. Instant money application 112 may be provided as a plug-in application to an existing IM client application. Alternatively, instant money application 112 is integrated into the IM client. User device 110a also includes a memory 118 storing a buddy list 102a associated with the device user.

In a further embodiment, user device 110 includes an application programming interface (API) that allows an application to seamlessly “plug-into” an IM client, contact list, and/or address list application. The “plugged-in” application could then be displayed as an icon on an interface displayed to the user.

A user device (e.g., user device 110b) includes an IM client having an instant money application 112 similar to user device 110a. However, in user device 110b the instant money list for the user is not stored locally on the user device. Instead, the instant money list may be stored in memory 166 of IM server 160, in memory 146 of instant money server 140, or the instant money list may be distributed between IM server 160 and instant money server 140.

An instant money list 102 is a list of other users (e.g., “buddies”) and sub-accounts such as bill pay sub-accounts, loans sub-accounts, special accounts, voucher sub-accounts, tax record sub-accounts, and/or payment pools to which a user may transfer, request, or promise to pay funds, or perform a status inquiry (e.g. inquiry of balance or due date). As would be appreciated by persons of skill in the art, other types of accounts or sub-accounts can be used with the present invention. The instant money list may include the user's IM “buddy list,” a contact list from a mobile phone or e-mail application, an address book or any combination thereof. Instant money lists can be stored locally, remotely, or in a browser cookie.

A user device (e.g., user device 110c) may also include an IM client 114, a separate instant money client 116, and a memory 118. In this embodiment, the IM client 114 is separate from the instant money client 116.

Instant money client 116 communicates with instant money server 140 using http, https, or html. In addition or alternatively, instant money client can communication with instant money server 140 using short message service (SMS), IM, e-mail, a proprietary communications protocol, or similar communications mechanism.

Instant message server 140 includes a communications module 142, a transaction module 144, and a memory 146. Communications module 142 enables communication between instant message server 140 and entities external to message originator system, such as user devices 110a-c, 170. Instant money server 140 communicates with these entities via communications network 120. It is noted that multiple communications modules 142 may execute in a single instant message server 140. For example, in one embodiment, communications module 132 is a TCP/IP stack.

Transaction module 144 performs functions associated with the financial transactions requested by users.

Memory 146 stores account information 150 for users. In addition, memory 146 may store instant money lists 102 for one or more user devices 110.

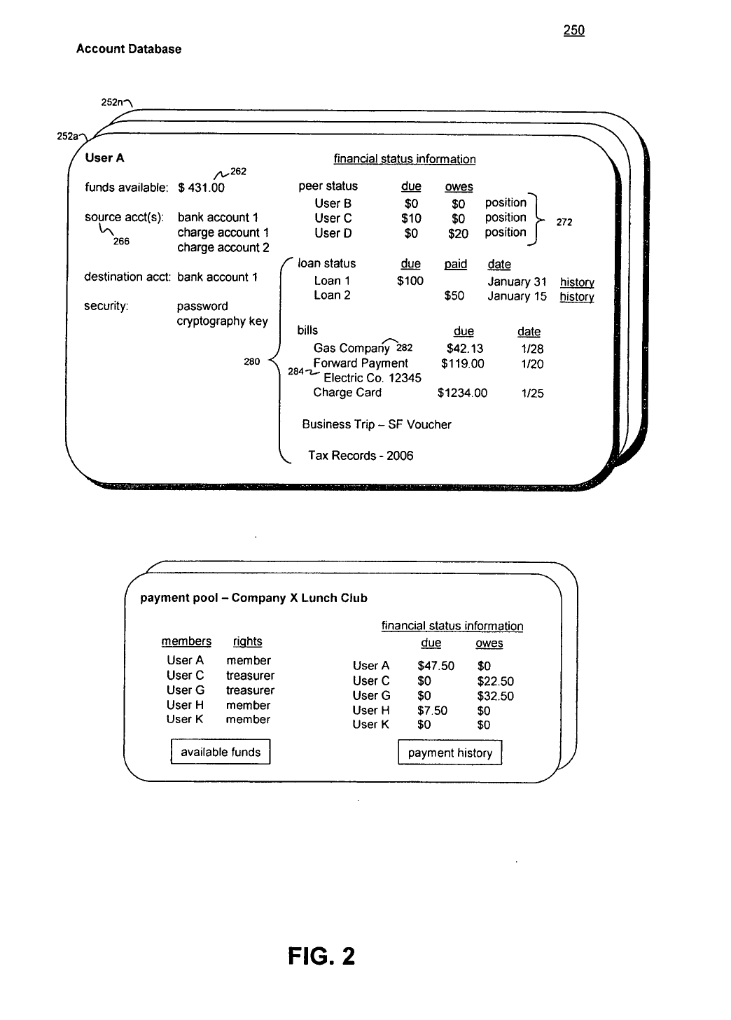

FIG. 2 depicts exemplary records stored in account database 250. Account database 250 includes a plurality of user records 252a-n. Each user record may include one or more peer entries 272 and/or one or more sub-accounts 280. A peer is another individual with whom a user engages in electronic transactions. A sub-account 280 belongs to an account and shares its control. A user can mark a sub-account as private, public, or semi-public. A private sub- account is only visible to the user. A public sub-account is visible to all users. A semi-public sub-account is visible to a predetermined group of users.

Multiple types of sub-accounts can be supported in a user account. A sub-account type is associated with processing by the transaction module. Thus, two different types of sub-accounts may have different behaviors. Types of sub- accounts include bill pay sub-accounts, loan sub-accounts, voucher sub-accounts, and tax record sub-accounts. Processing of transactions involving these sub-account types is described in further details in section 2.2.

A bill pay sub-account represents a charging relationship between a user and a company or similar entity. As depicted in FIG. 2, a bill pay account can be a stand-alone account 282 or a forward payment account 284. In the stand-alone account 282, a user can post funds to the user account and transfer funds to the bill pay account. The bill pay account name may indicate an account number (e.g., Gas Co. 123456) or the user may include the account number in a note with the transfer request. In the forward payment account 284, funds are transferred to the sub-account entity even if the entity does not have an instant money account. If the entity does not have an instant money account, the instant money server 140 may generate a check to the entity or perform an ACH transfer to the company.

For a bill pay sub-account, the charging entity (e.g., a utility, credit card company, a gym, etc.) could transmit the amount due on a bill and optionally the due date for the bill to the instant money server 140. A payment by the user then decreases the amount due. A subsequent message from the company (e.g., including the amount due for the next billing cycle) can reset the amount due or alternatively increase the amount due. Alternatively, the amount due can be left blank. In this alternative, a user may perform a promise to pay the company the amount due listed in a bill sent to the user via another means. The amount of the promise to pay can be added to the amount due field. In the bill pay example, the instant money server 140 acts as a payment interface between a user and the entity.

Financial/Banking system 190 is optional. When present, financial/banking system 190 includes a communications interface 192, a user source account 194, and a destination account 196. User source account 194 may be a bank account, a charge account, or a prepaid account. Thus, a user source account may be stored on a financial institution computer system. Similarly, destination account may be a bank account, charge account, prepaid account, or the like. Thus, destination account may be stored on the same or different financial institution computer system as the source account. Communications interface 192 facilitates communication between instant money server 140 and the one or more financial institution computer systems.

### 2.0 METHODS

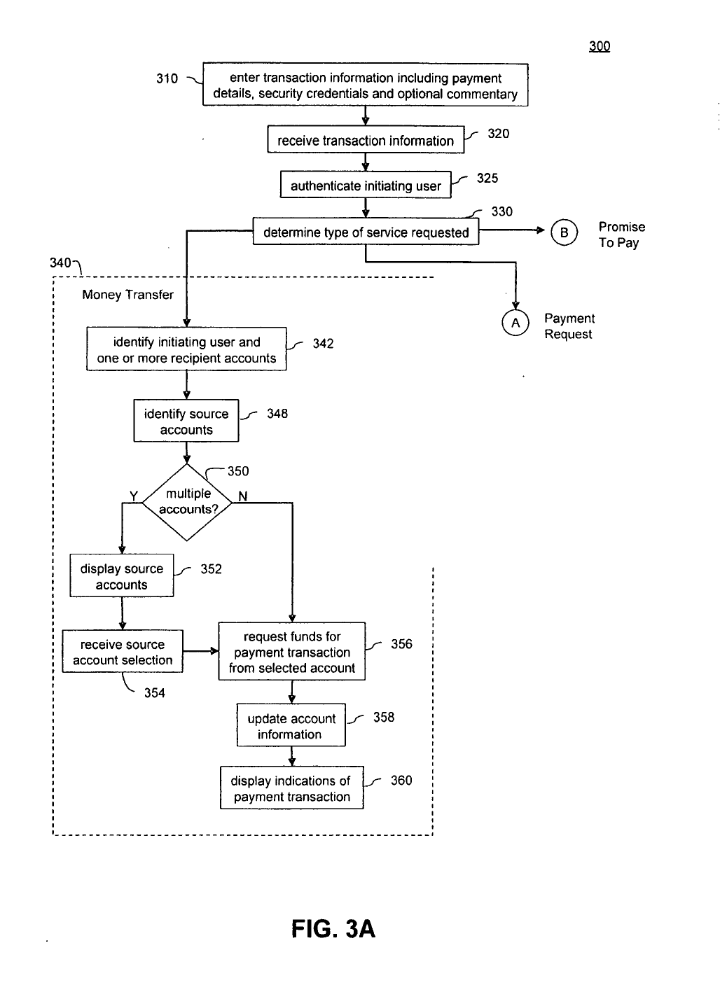

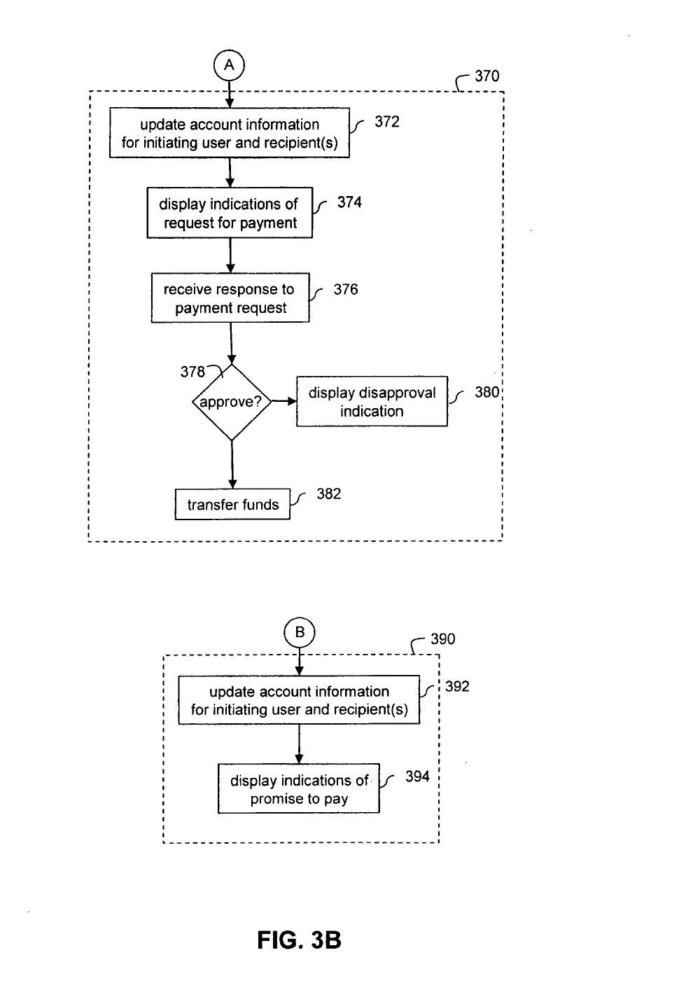

FIGS. 3A and B depict a flowchart 300 of a method for facilitating, recording, and/or tracking financial transactions among peers, according to an embodiment of the present invention. Flowchart 300 will be described with continued reference to the example operating environment depicted in FIG. 1. However, the flowchart is not limited to that embodiment. Note that some steps shown in flowchart 300 do not necessarily have to occur in the order shown.

In step 310, transaction information, including payment details, security credentials, and optional commentary, are entered by a user. The transaction information can be entered, for example, via an instant messaging (IM) client having integrated instant money 112, via an instant money client 116, via electronic mail application 175, or via a call center supporting the instant money application 182. In the context of flowchart 300, the user initiating the transaction process is referred to as the “initiating user” or “initiator” and the one or more users or sub-accounts receiving funds or payment promises via the transaction process are referred to as “recipients.” As would be appreciated by persons of skill in the art, other options are possible. For example, an initiating user may also receive funds and a recipient may also disburse funds. Exemplary options for step 310 are described below.

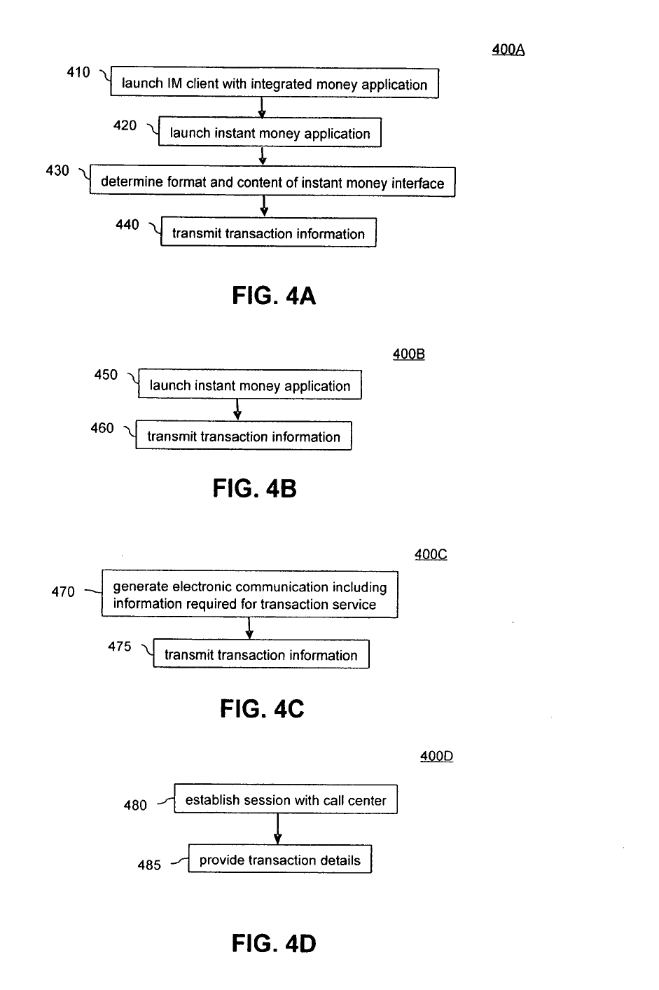

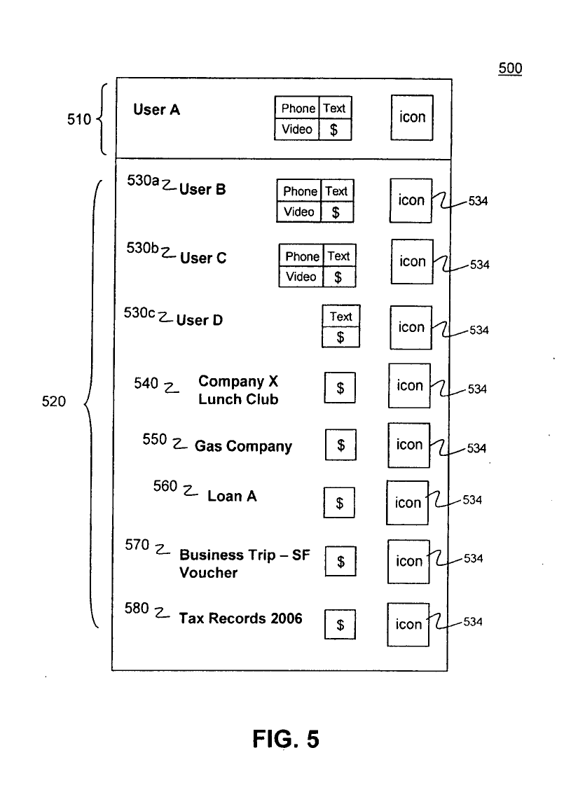

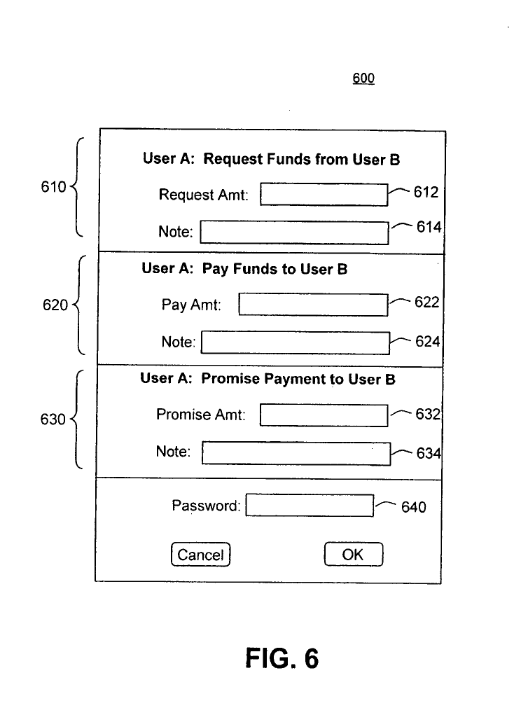

FIG. 4A depicts a flowchart 400A of a method for entering transaction information into an end-user device having an IM client with an integrated instant money application, according to an embodiment of the present invention. Flowchart 400A will be described with continued reference to the example operating environment depicted in FIG. 1 and the example interfaces depicted in FIGS. 5 and 6. However, the flowchart is not limited to that embodiment. Note that some steps shown in flowchart 400A do not necessarily have to occur in the order shown.

In step 410, the initiating user launches an IM client with the integrated instant money application. Client device 110a includes an exemplary IM client with an integrated instant money application 112. The IM client 112 retrieves the instant money list (also referred to as a “buddy list,” “contact list,” or “address list”) for the user. In an embodiment, the instant money list is stored locally in memory 118. In addition or alternatively, the instant money list is stored in memory 166 of IM server, memory 146 of instant money server 140, or distributed between the IM server and instant money server.

In an example embodiment, a user interface such as a graphical user interface (GUI) including the instant money list and available communication modes is then displayed to the user on device 110a. FIG. 5 depicts an exemplary GUI 500. GUI 500 includes a user portion 510 and a peer portion 520. Peer portion 520 includes one or more peer entries 530a-c. Peer portion may also include payment pool entries 540, bill pay entries 550, loan entries 560, voucher entries 570, and/or tax pay entries 580. Each peer entry 530 includes one or more supported communication/application modes 532 and an optional icon 534. Examples of supported communication/application modes are phone, text, video, and instant money (represented by ‘$’). As described above, other plug-in applications may be displayed as a communication/application mode. Icon 534 provides a visual representation for the peer entry. As would be appreciated by persons of skill in the art, GUI 500 can have other formats or include additional or less information. It is to be appreciated that in embodiments presented throughout the present application, user interfaces other than GUIs may be employed for displaying information or requesting user input.

In step 420, the initiating user launches the instant money application mode for an entry in peer portion 520.

In step 430, the format and content of the instant money interface is determined. For example, IM client 112 may communicate with the instant money server 140 to determine the layout of the instant money interface. Alternatively, the IM client 112 may determine the layout. In addition or alternatively, a default interface may be displayed.

FIG. 6 depicts an exemplary instant money interface 600. Instant money interface 600 may include one or more transaction services portions such as a payment request portion 610, a money transfer portion 620, and/or a promise to pay portion 630. Payment request portion 610 includes a request amount 612 and an optional note entry area 614. Payment request portion 610 may also include a mechanism for attaching a file, a picture, or similar document for transfer to the recipient. Money transfer portion 620 includes a payment amount 622 and an optional note entry area 624. Promise to pay portion 630 includes a promise amount 632 and an optional note entry area 634. Instant money interface 600 also includes an optional password entry field 640. It is to be appreciated that alternative methods of verification such as biometric verification (e.g. fingerprint or retinal scan) may be employed in addition to or as an alternative to passwords. As would be appreciated by persons of skill in the art, instant money interface 600 can have other formats and can include additional or less information.

In step 440, transaction information is transmitted from user device 110a. In this step, the initiating user enters payment details, security credentials (e.g., password), and/or optional user commentary into instant money interface and initiates transmittal of the information (e.g., by “clicking” OK button).

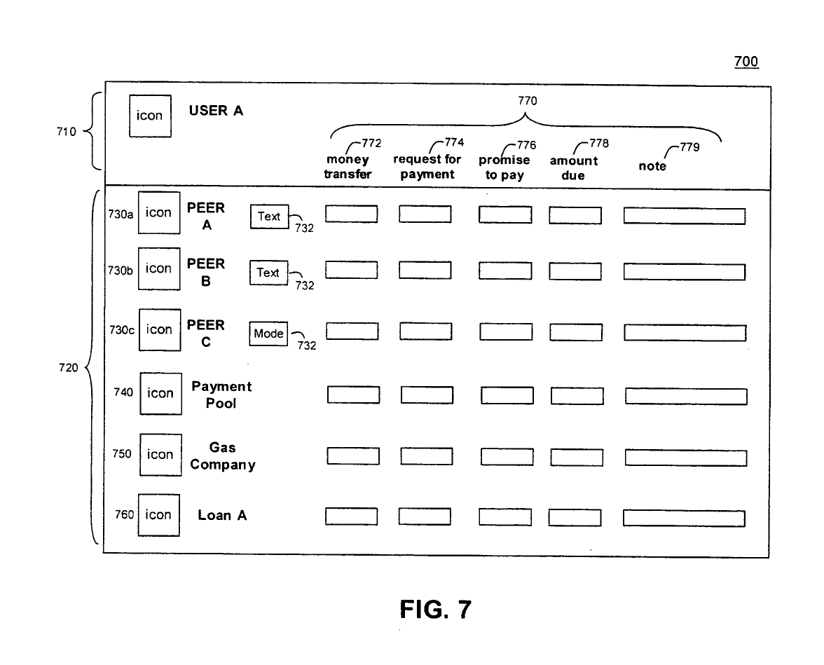

FIG. 4B depicts a flowchart 400B of a method for entering transaction information into an end-user device having a separate instant money client, according to an embodiment of the present invention. Flowchart 400B will be described with continued reference to the example operating environment depicted in FIG. 1 and the example interface depicted in FIG. 7. However, the flowchart is not limited to those embodiments. Note that some steps shown in flowchart 400B do not necessarily have to occur in the order shown.

In step 450, the initiating user launches the instant money client. Device 110c depicts an exemplary separate instant money client 116. Instant money client 116 retrieves the instant money list for the user. In an embodiment, the instant money list is stored locally in memory 118. In addition or alternatively, the instant money list is stored in memory 146 of instant money server 140.

In an example embodiment, a graphical user interface (GUI) or other user interface including the instant money list, available communication modes, and transaction services is then displayed to the user on device 110. FIG. 7 depicts an exemplary GUI 700. GUI 700 includes a user portion 710 and a peer portion 720. Peer portion 720 includes one or more user entries 730a-c. Peer portion may also include payment pool entries 740, bill pay entries 750, loan entries 760, voucher entries (not shown), and/or tax record entries (not shown). Each peer entry 730 includes one or more supported communication modes 732, an optional icon 734, and transaction service fields 770. Transaction service fields 770 include a money transfer field 772, a request for payment field 774, a promise to pay field 776, an amount due field 778, and an optional note field 779. Amount due field 778 displays amounts that the user owes to or is due from the associated peer or the associated account or sub-account. A user can enter an amount into the money transfer field, request for payment field 774, or promise to pay field 778 for the associated entry. As would be appreciated by persons of skill in the art, GUI 700 can have other formats or include additional or less information.

In step 460, transaction information is transmitted from user device 110 to instant money server 140. In this step, the initiating user enters payment details, security credentials (e.g., password), and/or optional user commentary into interface 700 and initiates transmittal of the information (e.g., by “clicking” an OK button (not shown)).

FIG. 4C depicts a flowchart 400C of a method for initiating a transaction service via an electronic communications mechanism, according to an embodiment of the present invention. Flowchart 400C will be described with continued reference to the example operating environment depicted in FIG. 1. However, the flowchart is not limited to that embodiment.

In step 470, the initiating user generates an electronic communication including information required for the transaction service being requested. For example, the initiating user may generate an e-mail message via e-mail application 175 of user device 170, a short message service (SMS) message, or any other type of electronic message. The type of information included in the message depends on the type of transaction service desired. For example, if money transfer is requested, the initiating user must include the initiating user identifier, a recipient identifier, and an amount. The message is addressed to the instant money server 140.

In step 475, transaction information is transmitted from user device 110 via a communications network 120.

FIG. 4D depicts a flowchart 400D of a method for initiating a transaction service via a call center, according to an embodiment of the present invention. Flowchart 400D will be described with continued reference to the example operating environment depicted in FIG. 1. However, the flowchart is not limited to that embodiment.

In step 480, the initiating user establishes a session with call center 180. For example, a session may be established via a wireless or wireline telephone call or an electronic “chat” mechanism. The session may be with a call center employee or with an interactive voice response (IVR) unit. Alternatively, a chatbot automated text response system may be employed.

In step 485, the initiating user provides transaction details such as the service desired, the recipient, and required transaction information (e.g., amount).

Returning to FIG. 3A, in step 320, transaction information including payment details, optional security credentials, and optional user commentary are received by instant money server 140. Payment details include type of the transaction service requested, recipient identifier, and payment amount.

In step 325, the initiating user is authenticated. This step is optional. As would be appreciated by a person of skill in the art, various forms of authentication can be used. For example, the initiating user may include a password, PIN, electronic signature, or similar information in the transaction information. Alternatively, upon receiving transaction information, the instant money server 140 may perform a challenge/response or similar authentication procedure.

In step 330, a determination of the type of transaction service requested by the initiating user is made. If money transfer service is requested, operation proceeds to step 340. If payment request service is requested, operation proceeds to step 370. If promise to pay a debt service is requested, operation proceeds to step 390.

In step 340, money transfer service is performed. Step 340 includes steps 342-360. Money transfer service involves the electronic transfer of funds between an initiating user and one or more recipients.

In step 342, accounts associated with the initiating user and the one or more recipients are identified. As described above, the recipient can be, for example, another individual, a monthly bill, or a loan. FIG. 2 depicts an exemplary record for an instant money user 252a.

In step 348, one or more source accounts are identified. For example, in FIG. 2, user A record 252a includes an available funds field 262 and source accounts 266. The available funds field 262 is a funding source representing funds currently available for transfer. Source accounts 266 represent alternative sources for funds. These funding sources may be stored in financial/bank network 190.

In step 350, a determination is made whether multiple source accounts are listed. If the user account has multiple source accounts, operation proceeds to step 352. If the user account does not have multiple source accounts, operation proceeds to step 356.

In step 352, the source account identifiers are displayed to the user. The user can then determine which account to use to fund the payment transaction.

In step 354, a selection of a source account is received from the user. Operation proceeds to step 356.

In an alternate embodiment, the user may set up rules for which source account to use. A user may identify that a source account be used for transactions with certain users. In addition or alternatively, a user may identify a source account be used for specific transactions. In the example of FIG. 2, user A may identify bank account 1 as the source account for any payment transactions with User B, User C, or User D and charge account 1 as the source account for Gas Company or Electric Company.

In step 356, funds for the payment transaction are requested from the selected source account. Transaction module 144 may request the difference between the funds available and the payment amount. Alternatively, transaction module 144 may request funds in excess of the deficiency.

In step 358, the account information 260 for the initiating user and the one or more recipients are updated.

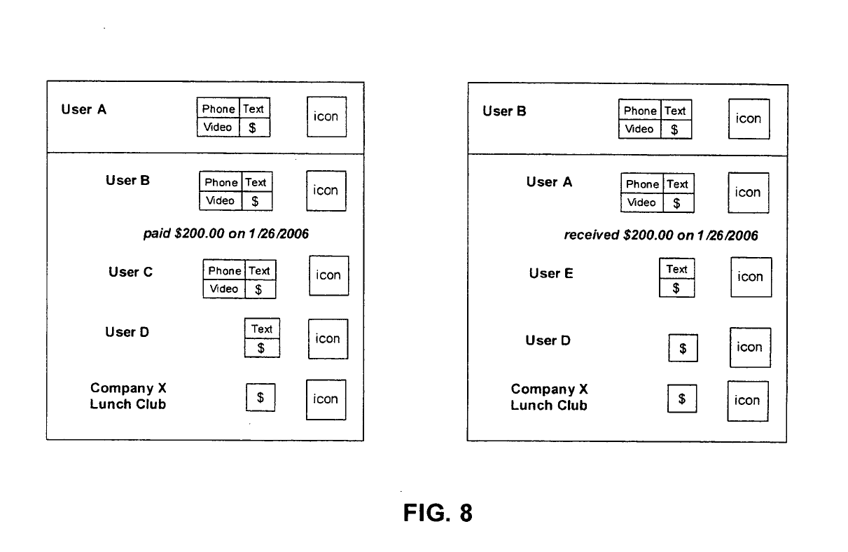

In step 360, indications of the payment transaction are displayed on the IM and/or instant money interface display of the initiating user and the recipients. FIG. 8 depicts exemplary IM interfaces including indications of the payment transaction. The IM interface of User A indicates the payment of $200.00 to User B on Jan. 26, 2006. The IM interface of User B indicates the receipt of a $200.00 payment from User A on Jan. 26, 2006. Indications of the payment transaction may also be sent via other mechanisms, including but not limited to, e-mail or automated phone call.

In step 370, payment request service is performed. Step 370 includes steps 372-382. Payment request service allows an initiating user to request payment from one or more recipients.

In step 372, account information 260 for the initiating user and the one or more recipients are updated. As shown in FIG. 2, a user account includes a position field for each listed field. The position field indicates the position of the user with respect to the peer taking into consideration any outstanding payment requests and promises to pay. For example, if the position value is negative, the user owes money to the peer and if the position value is position, the peer owes money to the user. In step 372, the position of the initiating user-recipient pair in the initiating user's account is increased by the amount of the payment request and the position of the recipient-initiating user in the recipient's account is decreased by the amount of the payment request.

In step 374, indications of the payment request are displayed on the IM and/or instant money interface display of the initiating user and the recipients. The interface displayed to the recipient of the payment request includes a mechanism to allow the user to approve or disapprove the payment request. The user may also be authenticated (e.g. via password and/or biometric identification) prior to sending the approval or disapproval of the payment request. A user may pre-specify their approval for certain transactions by explicit enumeration or by defining a set of rules. For example, a user may pre-approve the payment of certain bills each month.

In step 376, a response to the payment request is received by the instant money server 140.

In step 378, a determination is made whether the recipient approved the payment request. If the payment request was not approved, operation proceeds to step 380. If the payment request was approved, operation proceeds to step 382.

In step 380, indications of the disapproval of the payment request are displayed on the IM and/or instant money interface display of the initiating user and the recipients. In addition, the position of the initiating user and recipient may be updated by the amount of the request. That is, the initiating user and recipient are returned to their positions prior to the receipt of the request.

In step 382, the requested funds are transferred from the recipient to the initiating user.

Payment request services can be used in a variety of applications. For example, a company may support a promise to pay voucher system for its employees. In this application, the employee is the initiating user and the company is the recipient of the request. In the promise to pay voucher system, the company establishes one or more voucher application entities. For example, the company may set up one entity for all employees. Alternatively, the company may establish an entity for each business unit. In a further alternative, the company may establish an entity for each employee.

The employee then makes a request for payment to the appropriate company voucher entity. When transmitting the transaction details, the employee has the option of entering text notations (e.g., why fees were incurred, other employees in attendance, etc.) or attaching voice files, pictures (e.g., picture of receipt), invoices, copies of e-mail, or copies of confirmations, etc. In general, the employee could transmit any documentation that would assist the company in determining whether to reimburse the employee for the transaction.

The company can approve the payment request and transfer the requested funds to the account of the employee. In addition to the disapproval described above, the company can conditionally disapprove the request. In a conditional disapproval, the company can transmit a request to the employee for additional information to support the charges. For example, the company may request a receipt, if one was not provided. Alternatively, the company may request a listing of all attendees at an event.

In step 390, promise to pay service is performed. Step 390 includes steps 392 and 394. Promise to pay service allows an initiating user to make a promise to a peer to pay a debt in the future.

In step 392, account information 260 for the initiating user and the one or more recipients is updated. In this step, the position of the initiating user-recipient pair in the initiating user's account is decreased by the amount of the promise to pay and the position of the recipient-initiating user in the recipient's account is increased by the amount of the promise to pay.

In step 394, indications of the promise to pay are displayed on the IM and/or instant money interface display of the initiating user and the recipients.

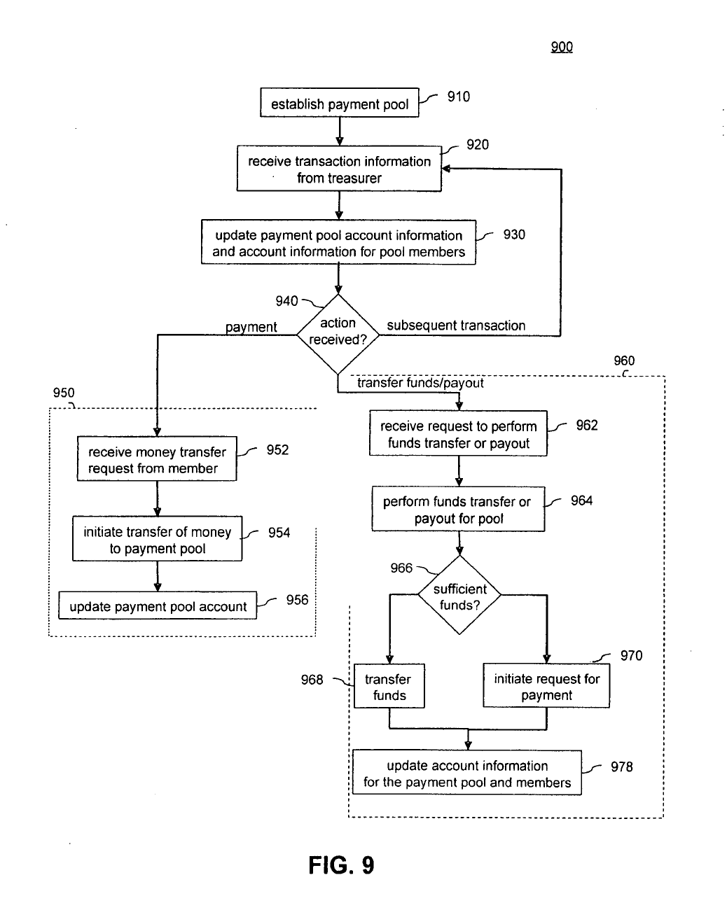

FIG. 9 depicts a flowchart 900 of a method for facilitating, recording, and/or tracking financial transactions among individuals, according to an embodiment of the present invention. Flowchart 900 will be described with continued reference to the example operating environment depicted in FIG. 1. However, the flowchart is not limited to that embodiment. Note that some steps shown in flowchart 900 do not necessarily have to occur in the order shown.

In step 910, a payment pool is established. A payment pool is an instant money account used to facilitate the transfer of funds among a group of individuals. For example, a payment pool may be established by a group of employees who go out to lunch together on a consistent basis.

A payment pool may be established via a variety of mechanisms. The instant money server provider may provide a web site for instant money application users. A user may connect to this web site using a browser. The web site includes a mechanism for users to establish a payment pool. The instant money application running on user devices 110 may also include the capability of establishing a payment pool. In addition or alternatively, a payment pool can be established via customer service representatives or IVR.

A payment pool is established by identifying a group of individuals to be included in the payment pool. The establishing user also sets rights for each member of the payment pool. Example rights include member rights and treasurer rights. A member can transfer funds to the payment pool account, accrue debts or credits with other members of the payment pool, and receive funds from the payment pool. A treasurer has all the rights of a member and can initiate funds transfer or payout for the payment pool. In funds transfer or payout processing, outstanding debts/credits of the payment pool are satisfied. After the payment pool is established, the treasurer can change rights of members of the payment pool. A payment pool must have at least one treasurer. However, a payment pool may have multiple treasurers.

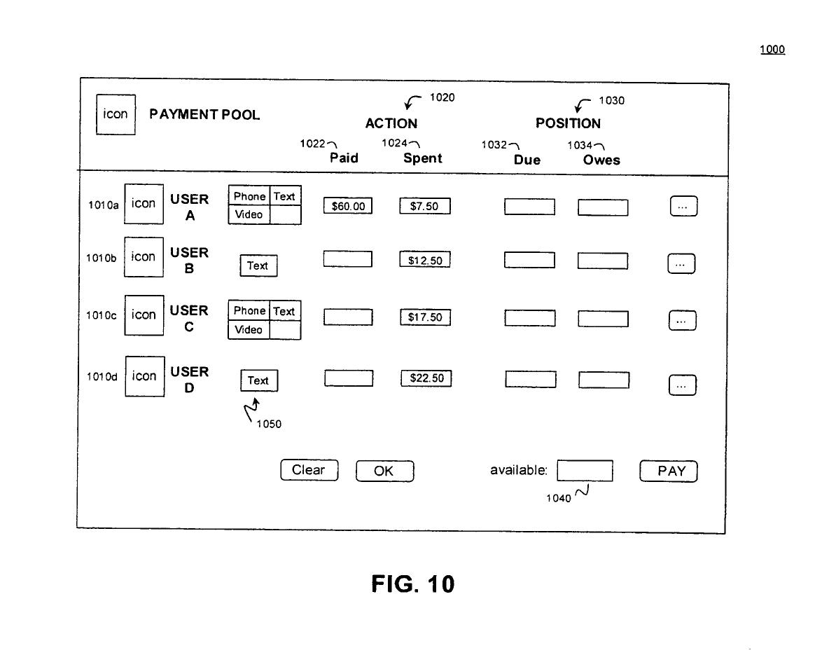

In step 920, transaction details are received from a treasurer of the payment pool. Transaction details include information on what members paid or spent and the associated amounts. A treasurer enters transaction details for a payment pool via an interface provided by the instant money application. FIG. 10 depicts an exemplary instant money payment pool interface 1000. As shown in FIG. 10, payment pool interface 1000 includes one or more member entries 1010. Each member entry includes action information 1020 and position information 1030. Action information 1020 includes a paid field 1022 and a spent field 1024. Paid field 1022 indicates the amount of un-reimbursed funds which a user has provided on behalf of the pool. Spent field indicates the amount of funds that a user has spent (i.e., to be reimbursed to one or more other users). The treasurer enters transaction details into the action field. In the example of FIG. 10, the treasurer has entered that user A paid $60.00 and spent $7.50, user B spent $12.50, user C spent $17.50, and user D spent $22.50.

Position information 1030 includes a due field 1032 and a owes field 1034. The position information displays the position of each user relative to the payment pool. The position information of a user may also be displayed on their personal instant money interface. Position information is provided by the transaction module 144 of the instant money server 140.

Each member entry includes one or more optional communication modes 1050. A communication mode is a supported instant messaging or communication mechanism. Example communication modes include text, phone, or video. Instant money payment pool interface 1000 also includes an available funds field 1040. The available funds field indicates the amount of funds that are currently on hand in the payment pool account. Interface 1000 also includes a mechanism to initiate funds transfer or payout for the payment pool. The funds transfer or payout initiation mechanism is depicted as a “pay button” in FIG. 10. As would be appreciated by persons of skill in the art, other mechanisms for initiating funds transfer or payout can be used with the invention.

In step 930, account information for the payment pool and members are updated. For example, in FIG. 2, the position information 290 in the payment pool account for the lunch club would be updated by the amounts received in the transaction details. In addition, the position of user A in user A's lunch club account entry 278 would be updated to reflect that user A paid $60.00 and spent $7.50. The payment pool entry of each member in the payment pool would be similarly updated.

In an embodiment, instant money server 140 requests acknowledgement of the transaction details from members of the payment pool prior to updating account information. For example, the instant money application may display the amounts received in the transaction details for the user on the user's instant money interface screen. The instant money application may then request a positive approval or acknowledgment of the details from the user.

In step 940, an action is received from a member and/or treasurer of the payment pool. The type of action is determined in this step. If a payment into the pool is received from a member, operation proceeds to step 950. If a request for funds transfer or payout is received from a treasurer, operation proceeds to step 960. If transaction details are received from a treasure, operation returns to step 920.

In step 950, payment to the payment pool is processed. Step 950 includes steps 952-956. 1121 In step 952, a money transfer request is received from a member of the payment pool. The money transfer request will identify the payment pool as the recipient for the money transfer and indicate the amount of funds to transfer to the payment pool.

In step 954, transaction module 144 initiates transfer of funds from the initiating user's account to the payment pool. Details of money transfer are described above in the discussion of FIG. 3.

In step 956, account information for the payment pool and initiating member are updated. For example, in FIG. 2, the available funds field 285 would be updated by the amount of received funds. In addition, the position of the initiating member would be updated in the payment pool account record and the individual user's account record.

In step 960, funds transfer or payout among the payment pool account and member accounts occurs. Step 960 includes steps 962-978.

In step 962, a request for funds transfer or payout is received from a treasurer of the payment pool.

In step 964, the transaction module 144 performs funds transfer or payout among the payment pool account and individual member accounts. Transaction module 144 uses the available funds and position details for each member to determine the appropriate actions to take.

In step 966, a determination is made whether sufficient funds exist in the payment pool to satisfy the debts owed to members by the payment pool (e.g., amount in owes field 1034). If sufficient funds exist, operation proceeds to step 968. If insufficient funds exist, operation proceeds to step 970.

In step 968, funds are transferred from the payment pool account to the accounts of one or more members. The amount of money transferred is based on the position of the user with respect to the payment pool.

In step 970, a request for payment is initiated by the payment pool to one or more members having outstanding debts to the payment pool (e.g., amount in “due field”). Details of request for payment processing are described above in the discussion of FIG. 3.

The transaction module 144 may delay final funds transfer and/or payout until sufficient funds are received. Alternatively, the transaction module 144 may execute an algorithm to determine how to distribute the available funds. The establishing member of the payment pool and/or treasurer may input rules to guide transaction module 144 on how to process transfers and/or payouts under this condition. Transaction module 144 may also have default processing rules.

In addition or alternatively, transaction module 144 may request transfer of funds from accounts of members with outstanding debts to the payment pool account. In an embodiment, a request is sent to the member to approve the transfer prior to any actual transfer of funds. Alternatively, the transfer of funds occurs automatically.

In step 978, account information for the payment pool and members is updated.

The following example describes the operation of a payment pool. User C, User M, User B, and User P establish a payment pool with User C being identified as the treasurer. The payment pool is named “Company X Lunch Club.” On the first day, members of the Lunch Club go to lunch. User P pays for lunch. User C's lunch costs $5, User M's lunch costs $10, User B's lunch costs $15, and User P's lunch costs $20. These details are entered by User C and transmitted to the instant money server 140. On the second day, User C pays for lunch. User C's lunch costs $7.50, User M's lunch costs $12.50, User B's lunch costs $17.50, and User P's lunch costs $22.50.

After day 2, the Lunch Club account indicates User C paid $60 and spent $12.50, User M paid $0 and spent $22.50, User B paid $0 and spent $32.50, and User P paid $50 and spent $42.50. Thus, User C is due $47.50, User M owes the Lunch Club $22.50, User B owes the Lunch Club $32.50, and User P is due $7.50 from the lunch club.

User C and User P then request funds transfer or payout for the entire amount owed to them. Note that User C may also request less than the entire amount owed. In response, User B pays $35 and User M pays $22.50 to the Lunch Club account. The transaction module initiates transfer of $47.50 to User C's personal account and $7.50 to User P's personal account. The Lunch Club account is then updated to reflect that the available funds for the Lunch Club are $2.50 and that User B is owed $2.50. Note that in this example, because User B paid into the account more than User B owed, the transaction module assumed that User B wished to accrue a positive balance with the Lunch Club and therefore did not return the funds to the User's personal account.

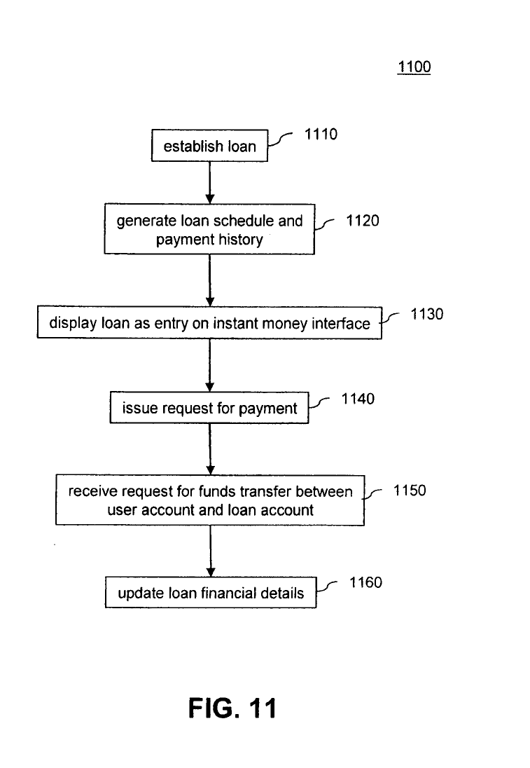

FIG. 11 depicts a flowchart 1100 of a method for facilitating, recording, and/or tracking loan payments, according to an embodiment of the present invention. Flowchart 1100 will be described with continued reference to the example operating environment depicted in FIG. 1. However, the flowchart is not limited to that embodiment. Note that some steps shown in flowchart 1100 do not necessarily have to occur in the order shown.

In step 1100, a loan is established with a user. The exact details of the loan are determined based on an agreement between the user and loan provider. The loan may be an interest-bearing loan or a non-interest bearing loan.

In step 1110, a loan schedule and payment history are generated based on the established agreement between the user and loan provider. The loan schedule will include payment dates and payment amounts.

In step 1120, the loan is displayed as an entry on the instant money or IM interface of the user. FIG. 5 depicts an IM interface including a loan entry 540. To make payments on the loan or access information about the loan, the user links to the instant money interface via the instant money communications mode link (depicted as a “$”).

In step 1130, a request for payment on the loan is issued to the user. The request for payment is issued either on the due date of payment or a predetermined number of days prior to the due date of payment. Request for payment processing is described above in the discussion of FIG. 3.

In step 1140, a request for funds transfer to the loan is received from the user. Request for funds transfer is described above in the discussion of FIG. 3.

In step 1150, the loan financial details in the user's account record are updated to reflect the received payment amount.

Note that steps 1130-1160 are repeated periodically throughout the lifetime of the loan. Also note that step 1120 may be performed again if certain payment criteria are met. For example, if the user pays in excess of the amount due, the loan agreement may allow for loan schedule and periodic payments to be updated.

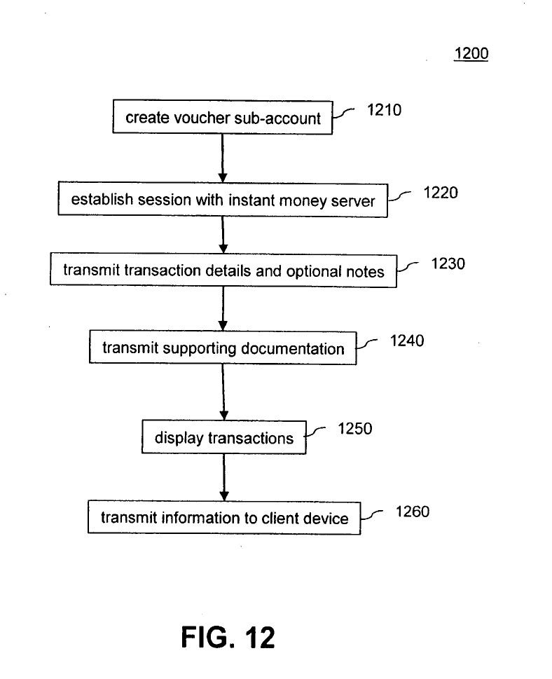

FIG. 12 depicts a flowchart 1200 of a method for recording and/or tracking voucher transactions, according to an embodiment of the present invention. Flowchart 1200 will be described with continued reference to the example operating environment depicted in FIG. 1. However, the flowchart is not limited to that embodiment. Note that some steps shown in flowchart 1200 do not necessarily have to occur in the order shown.

Via voucher sub-accounts, the instant money server 140 provides a mechanism for a user to record and track expenditures made on behalf of a third party. For example, an employee can use a voucher sub-account to track and record expenditures made on behalf of a company (e.g., business travel expenses). In a further example, a business can track and record expenditures made for a specific client. In general, a voucher sub-account can be used to track and record any expenditures for which the user expects reimbursement from another party.

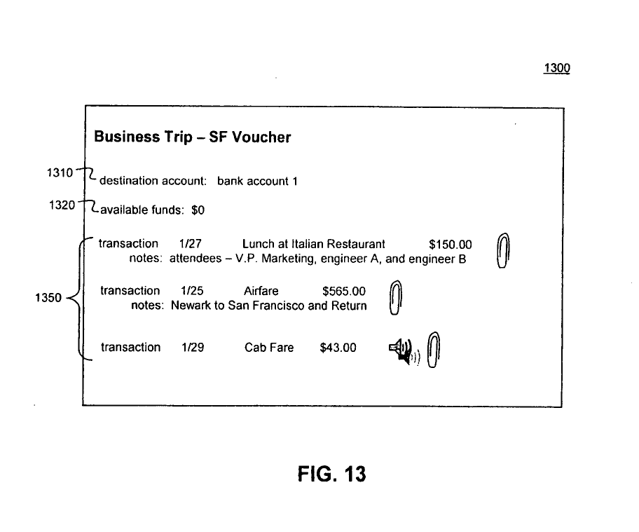

Specific processing and functionality for voucher sub-accounts is described below. FIG. 13 depicts exemplary fields in a voucher sub-account 1300. Voucher sub-account 1300 may include a destination account 1310, a funds available field 1320, and one or more transaction entries 1350. A transaction entry 1350 provides details about a specific recorded transaction.

In step 1210, the user creates a voucher sub-account. When a user establishes a voucher sub-account, the user may link the voucher sub-account to a destination account 1310 such as a bank account. A voucher sub-account may be established via a variety of mechanisms. For example, instant money server provider may provide a web site including a method for setting up a voucher sub- account. The instant money application running on user devices 110 may also include the capability of establishing a voucher sub-account. In addition or alternatively, a voucher sub-account can be established via customer service representatives or an IVR.

In step 1220, the user establishes a session with the instant money server 140. In an embodiment, the user establishes a voice call with a call center. The user may then interact with a call center operator or with an IVR. In addition or alternatively, the user may initiate a text message or instant message exchange with the instant money server 140.

In step 1220, the call center determines identification information for the device initiating the session. The identification information may be transmitted to the call center during call set-up. For example, the calling party number or automatic number identification (ANI) provided in call set-up signaling may be used as the identification information. Alternatively, the call center may prompt the user for identification information. The call center may also prompt the user for identification of the voucher sub-account. Optionally, the call center may perform additional steps to authenticate the presented identity, e.g., by requesting a PIN or password from the user.

In step 1230, the user transmits or communicates details of the voucher transaction. The user may also provide optional notes on the transaction. For example, the user may provide the date of the transaction, description of the transaction, and amount. The user may also provide notes that would help the recipient determine whether to approve the reimbursement. For example, the user may list the attendees at a lunch.

In step 1240, the user transmits supporting documentation for a transaction. Note that step 1240 can occur during the session established in step 1220. In addition, step 1240 can occur during a separate session. Supporting documents may include voice files, pictures (e.g., picture of receipt), copies of e- mail, or copies of confirmations, text explanations, video clips, or similar. In general, a user could transmit any documentation that would assist the recipient in determining whether to reimburse the user for the transaction.

FIG. 13 illustrates exemplary transaction entries 1350. Each transaction entry may include a date, a description (e.g., lunch), and notes (e.g., attendees: V.P. Marketing, engineer A, engineer B). Furthermore, each transaction entry may include one or more voice, picture, text, video, or similar attachments. In step 1250, a user accesses the instant money server 140 to view the voucher sub-account. The instant money server 140 may provide a web site through which a user may view his or her account and sub-accounts. For voucher sub-accounts, the web site may offer a variety of functionalities. For example, the web site may allow the user to download the recorded transaction details to a device. Alternatively, the web site may provide an application for automatic generation of a voucher for the user.

In step 1260, requested information is transmitted to the user. For example, the user may request transaction details. In addition or alternatively, the user may generate a voucher and request the completed voucher be transmitted to the user's device or a device associated with a third party.

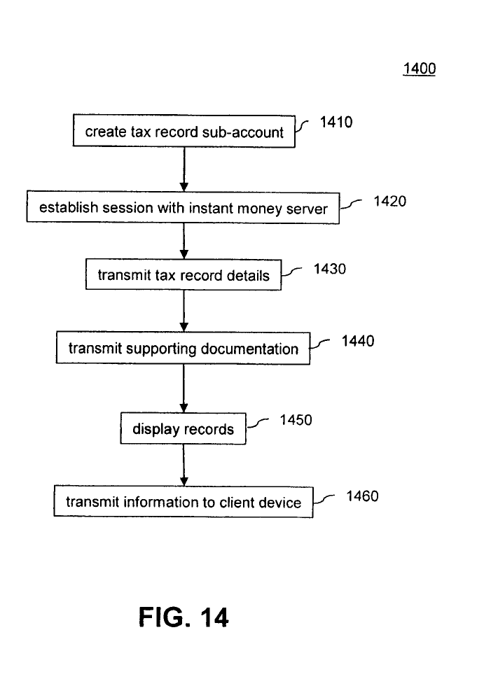

FIG. 14 depicts a flowchart 1200 of a method for recording and/or tracking charitable contributions or other documentation for tax purposes, according to an embodiment of the present invention. Flowchart 1400 will be described with continued reference to the example operating environment depicted in FIG. 1. However, the flowchart is not limited to that embodiment. Note that some steps shown in flowchart 1400 do not necessarily have to occur in the order shown.

Via tax record sub-accounts, the instant money server 140 provides a mechanism for a user to record and track charitable contributions and other documentation for tax purposes. A tax record sub-account provides a convenient mechanism for a user to keep records for tax purposes. Tax record sub-accounts are similar in operation to voucher sub-accounts.

In step 1410, the user creates a tax record sub-account. A tax record sub-account may be established via a variety of mechanisms. For example, the instant money server provider may provide a web site including a method for setting up a tax record sub-account. The instant money application running on user devices 110 may also include the capability of establishing a tax record sub-account. In addition or alternatively, a voucher sub-account can be established via customer service representatives or an IVR.

In step 1420, the user establishes a session with the instant money server 140. In an embodiment, the user establishes a voice call with a call center. The user may then interact with a call center operator or with an IVR. In addition or alternatively, the user may initiate a text message or instant message exchange with the instant money server 140.

In step 1420, the call center determines identification information for the device initiating the session. The identification information may be transmitted to the call center during call set-up. For example, the calling party number or automatic number identification (ANI) provided in call set-up signaling may be used as the identification information. Alternatively, the call center may prompt the user for identification information. The call center may also prompt the user for identification of the tax record sub-account. Optionally, the call center may perform additional steps to authenticate the presented identity, e.g., by requesting a PIN or password from the user.

In step 1430, the user transmits or communicates tax record details. The user may also provide optional notes for the record.

In step 1440, the user transmits supporting documentation for the tax record. Note that step 1440 can occur during the session established in step 1420. In addition, step 1440 can occur during a separate session. Supporting documents may include voice files, pictures (e.g., picture of receipt), text explanations, video clips, or similar.

In step 1450, a user accesses the instant money server 140 to view the tax record sub-account. The instant money server 140 may provide a web site through which a user may view his or her account and sub-accounts.

In step 1460, requested tax record information is transmitted to the user.

### 3.0 ALTERNATE EMBODIMENTS

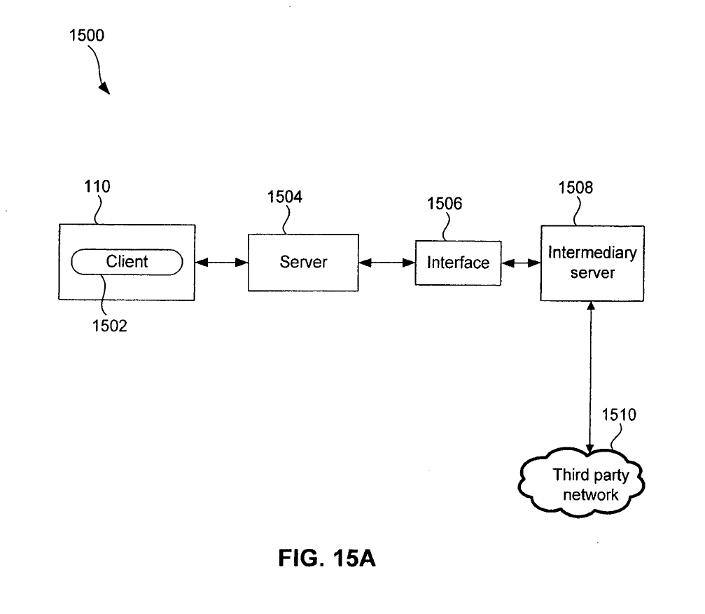

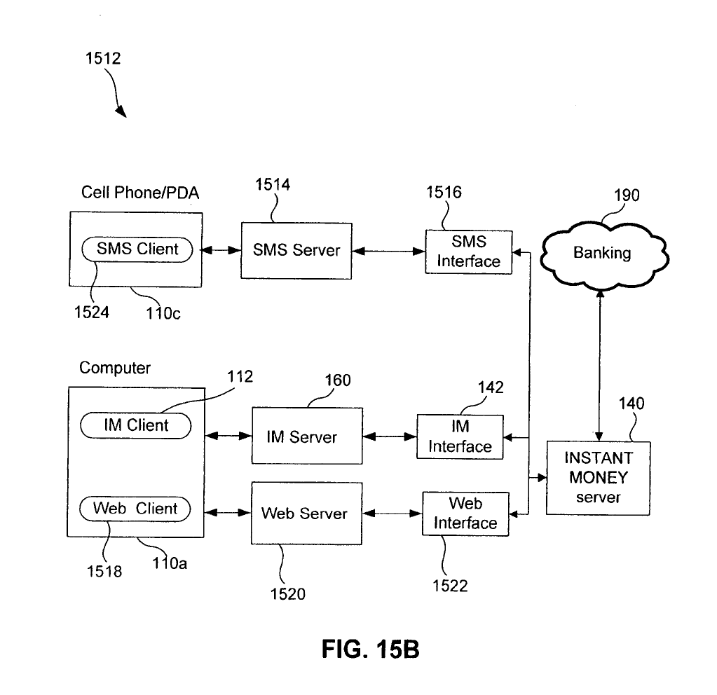

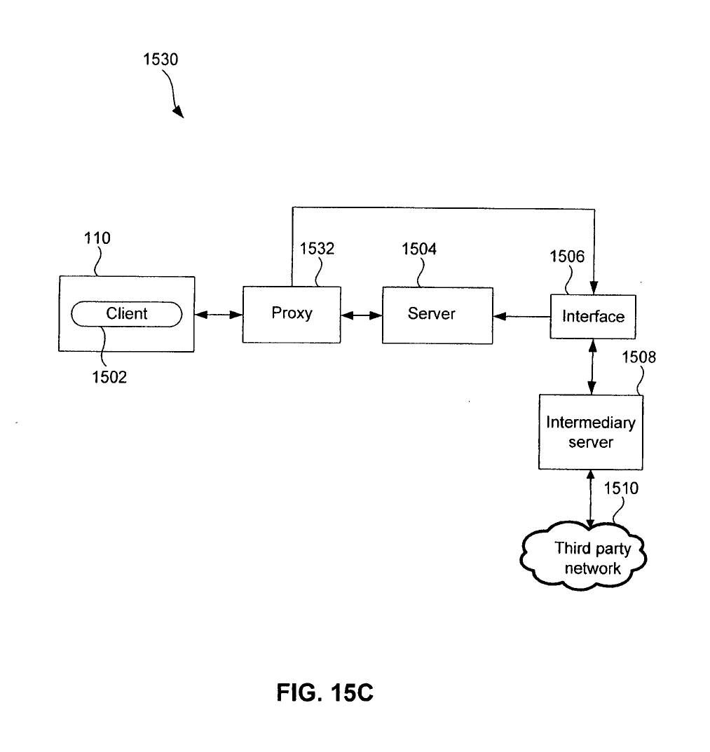

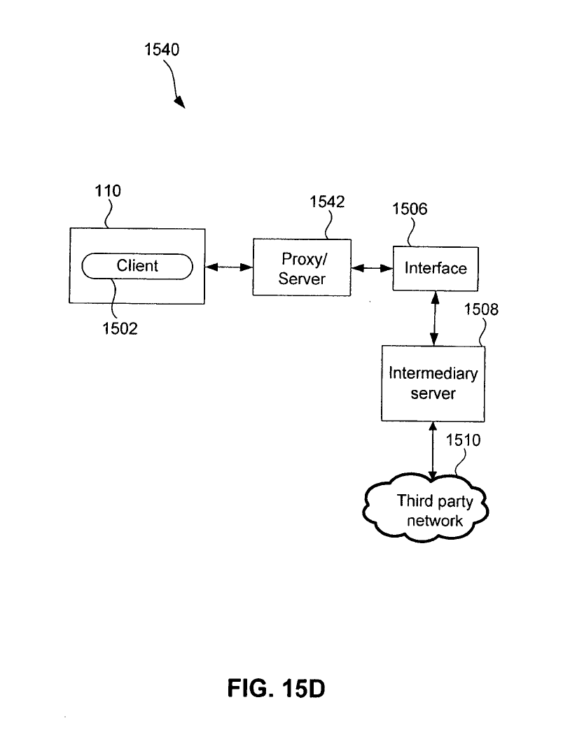

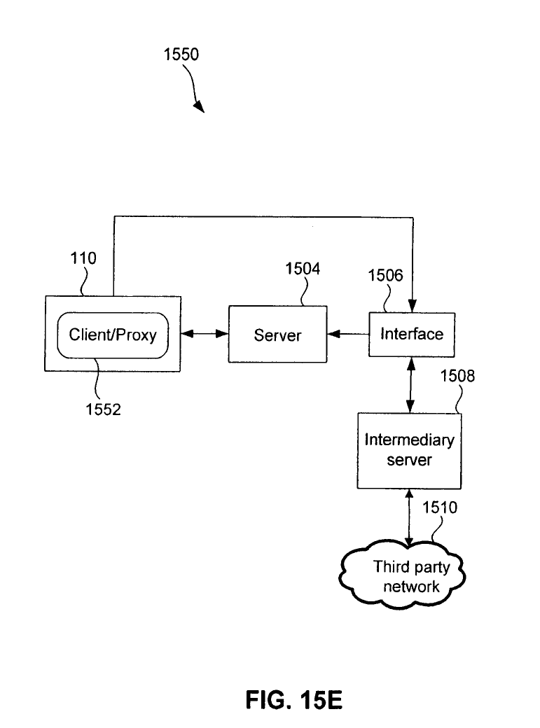

FIG. 15A illustrates a high-level block diagram of an exemplary system 1500 for facilitating transactions using a messaging protocol, according to an embodiment of the invention.

System 1500 includes user device 110, server 1504, interface 1506, intermediary server 1508 and third party network 1510. In embodiments, server 1504 may be, for example, IM server 160 depicted in FIG. 1, interface 1506 may be IM interface 142 depicted in FIG. 1, intermediary server 1508 may be instant money server 140 depicted in FIG. 1 and third party network 1510 may be financial/banking network 190 depicted in FIG. 1. Client 1502 running on user device 110 may be, for example IM client 112 or instant money client 116 depicted in FIG. 1.

Client 1502 may provide, for example, a GUI or other user interface to display information to a user and to accept input from the user. Client 1502 formats user input data into the format/protocol required by server 1504. For example, if server 1504 is an IM server 160, then client 1502 may format data according to an existing instant messaging protocol/format. An example of an instant messaging protocol/format is XML-based protocol such as EXtensible Messaging and Presence Protocol (XMPP) used in Jabber instant messaging clients and servers. IM server 160 typically forwards the data received from client 1502 in XMPP format/protocol to interface 1506 without any further formatting. Client 1502 receives response to a request sent to intermediary server 1508 via interface 1506 and server 1504. The request may be, for example a financial transaction as described above in section 3.2. If server 1504 is an IM server 160, then the response is received by client 1502 in an XML-based protocol. Client 1502 formats the received XML-based response and may display it in, for example, a GUI format. If client 1502 is a Short Message Service (SMS) client running on a mobile device such as a wireless phone 110, then messages are formatted by client 1502 in an SMS format/protocol and sent to an SMS server 1504.

Server 1504 serves as a communications interface between client 1502 and interface 1506. Server 1504 uses existing authentication procedures to authenticate a user using client 1502. The existing authentication procedures may be, for example, a login/password that a user enters. Server 1504 may be, for example, instant messaging server 160.

Interface 1506 serves as a translator between the client 1502 and the intermediary server 1508. In an exemplary embodiment, interface 1506 receives messages from client 1502 in a first format/protocol, for example, an XML-based or SMS format/protocol, and translates them into an intermediary format/protocol before sending it to intermediary server 1508. The intermediary format/protocol may be any form of encoded text over internet protocol or encoded text over socket e.g., American Standard Code for Information Interchange (ASCII) Text Over Transmission Control Protocol/Internet Protocol (TCPIP). The ASCII Text Over TCP/IP is abbreviated as ATOT throughout the specification. In an embodiment, the encoded text may be ASCII or Unicode. Interface 1506 receives messages from intermediary server 1508 in the, for example, ATOT format/protocol, changes the format/protocol of the received messages into a second format/protocol, for example, an XML-based format and forwards them to client 1502 via server 1504.

Client 1502 connects to intermediary server 1508 via server 1504 and interface 1506. Intermediary server 1508 may serve as a broker between the user and third party network 1510. For example, if a user desires to buy an item, he/she may use a “favorites” or “buddy list”, e.g. list 102, on client 1502 to specify a store, an item and a price range. Intermediary server 1508 communicates with third party network 1510 to determine the availability of the item in the specified stores. Intermediary server 1508 has user information including but not limited to shipping address, billing address and financial account information. If a match for the desired item within the specified price range is found, the intermediary server 1508 asks for confirmation from the user and upon receiving confirmation, completes the transaction with third party network 190. Example use of system 1500 for financial transactions is described below with reference to FIG. 15B. In addition or alternatively, intermediary server 1508 may be configured to broker non-financial transactions, for example, for contracting a service provider like a maid. In this case, third party network 1510 is a network of service providers. Client 1502 is enabled to receive user input of a specific date and time to request the services of a service provider. Client 1502 is configured to send this information to intermediary server 1508 via server 1504 and interface 1506. Intermediary server 1508 may be configured to interact with third party network of service providers 1510 to find service providers available within the specified time frame. Intermediary server 1508 is enabled to provide the user with available options for service providers, receive the user's selection and notify the service provider. The user may pay the service provider either via a financial transaction using intermediary server 1508 as described below with reference to FIG. 15B or pay them in person. System 1500 can support additional types of services or applications. As would be appreciated by persons of skill in the art, one or more of the server 1504, interface 1506 and intermediate server 1508 can be on the same or different physical server systems.

FIG. 15B illustrates a high-level block diagram 1512 for facilitating financial transactions according to an embodiment of the present invention.

System 1512 includes user devices 110a and 110c, SMS server 1514, IM server 160, web server 1520, SMS interface 1516, IM interface 142, web interface 1522, instant money server 140 and banking network 190. User device 110a can be any computational device including, but not limited to a laptop or a desktop computer. User device 110a may include an IM client 112 and a web client 1518 which may be a browser. User device 110c can be any device capable of receiving or initiating electronic communication including but not limited to a wireless devices running an SMS client 1524.

SMS client 1524 connects to SMS server 1514 and SMS interface 1516. SMS client 1524 may be configured to allow a user to use a buddy list 102 stored on user device 110 to identify a recipient of an amount of a financial transaction. SMS interface 1516 is enabled to translate the request for financial transaction from a messaging format/protocol specific to SMS client 1524 (e.g. an SMS format) into an intermediate format/protocol (e.g. ATOT) and send it to instant money server 140 which in turn conducts the financial transaction with banking network 190. Alternatively, if a user desires to use another means of communication, such as user device 110a, the same transaction can also be conducted via IM client 112, IM server 160, IM interface 142, instant money server 140 and banking network 190. IM client 112 may be configured to receive a transaction request from a user, format it into a messaging format/protocol (e.g. XMPP) and send it to IM interface 142 via IM server 160. IM interface is configured to translate the request from the messaging format/protocol (e.g. XMPP) into an intermediate format (e.g. ATOT) and send it to instant money server 140. Instant money server 140 is configured to interact with banking network 190 to conduct the financial transaction. Alternatively, the client may use web client 1518 running on user device 110a. Web client 1518 is configured to connect with web interface 1522 via web server 1520. Web client 1518 connects to instant money server 140 and uses instant money server 140 as an intermediary server to communicate with banking network 190 and conduct the transaction.

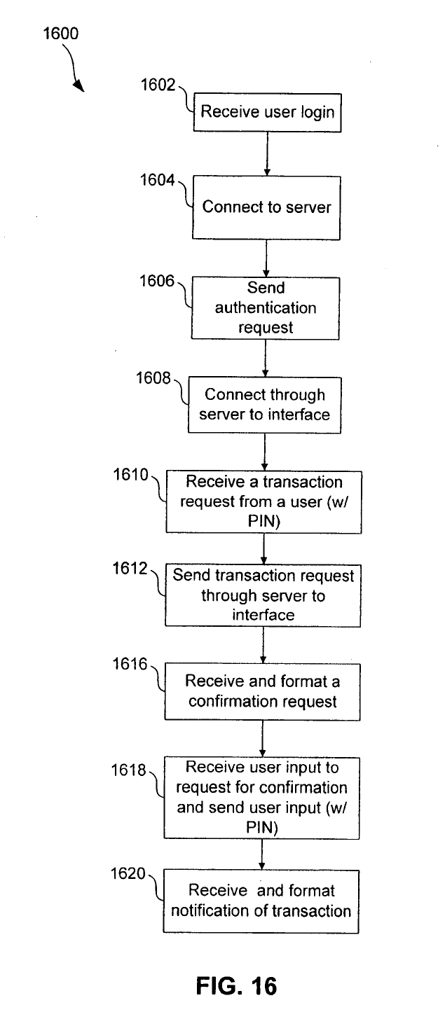

It is to be appreciated that in system 1512, part or all of a financial transaction may be completed via different communication routes. A user may initiate a transaction via one mode of communication, for example SMS, and receive notification/confirmation related to the request via another means of communication such as instant message or a web service or e-mail. Details of steps performed by clients, servers and interfaces are described below with reference to flowcharts in FIGS. 16-19.

FIG. 15C illustrates a high level block diagram of an exemplary system 1530 including a proxy 1532 for facilitating transactions, according to an embodiment of the present invention.

System 1530 includes user device 110, proxy 1532, server 1504, interface 1506, intermediary server 1508 and third party network 1510. As described above, in embodiments, server 1504 may be, for example, IM server 160, interface 1506 may be IM interface 142, intermediary server 1508 may be instant money server 140 and third party network 1510 may be financial/banking network 190 depicted in FIG. 1. Client 1502 running on user device 110 may be, for example IM client 112 or instant money client 116 depicted in FIG. 1. Proxy 1532 is an IM proxy when used in conjunction with IM client 112 and IM server 160. Alternatively proxy 1532 is a SMS proxy when used in conjunction with SMS client 1524 and SMS server 1514. In the present embodiment, proxy 1532 is also coupled to interface 1506 and is enabled to send messages to interface 1506. In alternate embodiments, proxy 1532 is enabled to send/receive messages to/from interface 1506. Proxy 1532 is also coupled to server 1504 and can send/receive messages to/from server 1504.

In the example presented in FIG. 15C, proxy 1532 is enabled to monitor messages sent from client 1502 and determine whether the message is a transaction request based on keywords, syntax, or semantics of the message. Upon detecting that a message is a transaction request, proxy 1532 translates the request from an instant messaging protocol, e.g. SMS protocol or XMPP protocol, to a text over internet protocol, e.g. ATOT, and forwards the message to interface 1506. Interface 1506 in turn forwards the translated message to intermediary server 1508.

Proxy 1532 may use keywords, syntax or semantics of the message to determine whether the message is a transaction request. Examples of keywords, syntax, semantics etc. include words like “pay”, “deposit”, Instant Money (“IM”), “Send $” etc. As would be appreciated by persons of skill in the art, other means determining whether a message is a transaction request may be used with the present invention.

In an alternate embodiment, upon detecting whether the message is a transaction request, proxy 1532 is enabled to forward the message to interface 1506. Interface 1506 translates the message from an instant messaging protocol to a text over internet protocol, before sending it to intermediary server 1508.

Messages which are not transaction requests, i.e. do not have the keywords, semantics or syntax of a transaction request are forwarded by proxy 1532 to server 1504. Messages and transaction request confirmations/notifications from server 1504 are forwarded by proxy 1532 to client 1502.

An example messaging conversation including a transaction request between a first instant messaging user “User 1” and a second instant messaging user “User 2” is provided below for explanatory purposes:

1. User 1 to User 2: “Hello”

2. User 2 to User 1: “You owe me $2”

3. User 1: “Send $2 to User 2”

4. Intermediary Server to User 1: “Enter Password: XXXXX”.

5. Intermediary Server to User 1: “Confirm $2 payment to User 2: Yes”.

6. Intermediary server to User 1 and User 2: “$2 sent to User 2 from User 1”.

In the above example, messages 1 and 2 are regular instant messages and do not contain keywords identifying them as transaction requests. Message 3 contains the keyword “Send $”. Proxy 1532 is enabled to detect the keyword “Send $”, translate message 3 from the instant messaging protocol in use into a text over internet protocol and transmit the message to interface 1506. Interface 1506 forwards the translated message to intermediary server 1508. In response to the transaction request, as described above, intermediary server 1508 sends message 4 to User I requesting a password. Upon verification of the password, intermediary server 1508 is enabled to request User 1 for confirmation of the transaction in message 5. Upon receiving confirmation from User 1, intermediary server 1508 is enabled to conduct the transaction, as described above, via third party network 1510. Upon completion of the transaction, intermediary server is enabled to send a notification message 6 to User 1 and User 2 indicating that the transaction has been completed with $2 being sent to User 2.

In an embodiment, messages 1 and 2 are sent via proxy 1532 and server 1504, message 3 is sent via proxy 1532 and interface 1506 and messages 4-6 are sent via interface 1506 and server 1504. In alternate embodiments, messages 1 and 2 are sent via proxy 1532 and server 1504, message 3 is sent via proxy 1532 and interface 1506 and messages 4-6 are sent via interface 1506 and proxy 1532.

FIG. 15D illustrates a high level block diagram of an exemplary system 1540 including a Proxy/Server 1542 for facilitating transactions, according to an embodiment of the present invention.

System 1540 includes user device 110, Proxy/Server 1542, interface 1506, intermediary server 1508 and third party network 1510. In the present example, Proxy/Server 1542 includes functionality of both proxy 1532 and server 1504. In an embodiment, interface 1506 is IM interface 142, intermediary server 1508 is instant money server 140, third party network 1510 is financial/banking network 190. Proxy/Server 1542 is IM proxy/IM Server when used in conjunction with an IM client 112 and includes functionality of IM server 160 and Proxy 1532. Alternatively Proxy/Server 1542 may be a SMS Proxy/SMS Server when used in conjunction with SMS client 1524. Proxy/Server 1542 is coupled to interface 1506.

In the present example, Proxy/Server 1542 is enabled to receive messages from client 1502 and, as described above, determine whether the message is a transaction request. If the message is a transaction request, Proxy/Server 1542 is enabled to forward the message to interface 1506. In an alternate embodiment, Proxy/Server 1542 is enabled to translate the transaction request from an instant messaging protocol into a text over internet protocol and then forward the transaction request to interface 1506.

Proxy/Server 1542 is also enabled to receive messages from interface 1506 in an instant messaging protocol/format and forward the messages to client 1502. In another embodiment, Proxy/Server 1542 receives messages from interface 1506 in text over internet protocol, translates the messages into an instant messaging protocol and sends it to client 1502.

FIG. 15E illustrates a high level block diagram of an exemplary system 1550 including a Client/Proxy 1552 for facilitating transactions, according to an embodiment of the present invention.

System 1550 includes user device 110 running Client/Proxy 1552, server 1504, interface 1506, intermediary server 1508 and third party network 1510. In the present example, Client/Proxy 1552 includes functionality of both proxy 1532 and client 1502. In an embodiment, interface 1506 is IM interface 142, intermediary server 1508 is instant money server 140 and third party network 1510 is financial/banking network 190 depicted in FIG. 1. Client/Proxy 1552 is an IM Client/IM Proxy when used in conjunction with an IM server 160 and includes functionality of IM client 112 or instant money client 116. Client/Proxy 1552 is an SMS Client/SMS Proxy when used in conjunction with SMS client 1524. In the present embodiment, Client/Proxy 1552 is coupled to server 1504.

Client/Proxy 1552 is enabled to determine whether a message is a transaction request as described above. If the message is a transaction request, Client/Proxy 1552 is enabled to bypass server 1504 and send the message to interface 1506. In another embodiment, Client/Proxy 1552 is enabled to translate the transaction request from an instant messaging protocol into a text over internet protocol and then send it to interface 1506.

Client/Proxy 1552 is also enabled to receive messages from server 1504 in an instant messaging protocol.

FIG. 16 illustrates an example flowchart 1600 of a method for facilitating transactions from the perspective of a client 1502 for facilitating a transaction, according to an embodiment of the invention. Flowchart 1600 will be described with continued reference to the example operating environment depicted in FIGS. 15A and 15B. However, the flowchart is not limited to that embodiment. Note that some steps shown in flowchart 1600 do not necessarily have to occur in the order shown. The client may be, for example IM client 112 running on computing device 110a.

In step 1602, client 1502 receives a user's login information. The login information is, for example, a username and a password. The login information may be entered, for example, via a user interface such as a GUI provided by the client 1502.

In step 1604, client 1502 connects to server 1504. The server is, for example, IM server 160.

In step 1606, client 1502 sends an authentication request to server 1504. The authentication request is used to verify the identity of a user prior to allowing access to EM application 1504. The authentication request includes, for example, a user login and password. If the server is an IM server or a web server, then the user's login and password stored on the IM or web server is compared against those sent in the authentication request. Alternatively, server 1504 may communicate with a separate authentication server or module to authenticate the user. In an embodiment, for an IM client 112, the authentication request is formatted and sent in a messaging protocol specific to client 1502 e.g. EXtensible Messaging and Presence Protocol (XMPP) which is an XML-based protocol used in Jabber instant messaging clients and servers. For an SMS client 1524, the authentication request is formatted in an SMS format.

In step 1608, if the user has been successfully authenticated, client 1502 connects to interface 1506 via server 1504. The interface may be, for example, IM interface 142.

In step 1610, client 1502 receives a transaction request from the user. The request may be to transfer funds to a recipient, arrange for a service provider or purchase an item. In an embodiment, the user may have to enter a Personal Identification Number (PIN) along with the request for security purposes.

In step 1612, client 1502 formats request in, for example, XMPP or SMS and sends the request received in step 1610 to interface 1506 via server 1504.

In step 1616, client 1502 receives a confirmation request from an intermediary server via the interface and communication server. The intermediary server may be for example, instant money server 140. The confirmation request is formatted by the client and displayed to the user, for example, in a GUI or other user interface. The confirmation request is to determine whether the user wishes to proceed with the transaction.

In step 1618, client 1502 displays a screen requesting that the user confirm the requested transaction (e.g. “Do you wish to proceed with the transaction?”). Client 1502 then receives user input. The user may also, optionally, have to input a PIN to confirm the transaction. The user input is formatted in, for example, XMPP and sent to the intermediary server via communication network and interface.

In step 1620, client 1502 receives a notification of success or failure of the desired transaction from intermediary server 1508, via interface 1506 and server 1504. The notification is received in, for example, XMPP and is formatted and displayed to the user, for example, in a GUI.

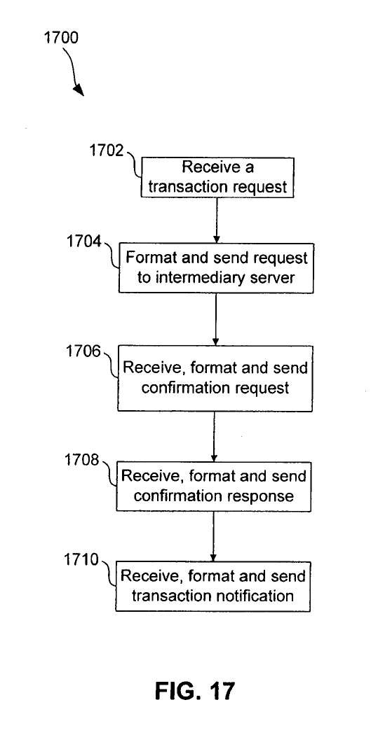

FIG. 17 illustrates an example flowchart 1700 of a method for facilitating transactions from the perspective of interface 1506, according to an embodiment of the invention. Flowchart 1700 will be described with continued reference to the example operating environment depicted in FIGS. 15A and 15B. However, the flowchart is not limited to that embodiment. Note that some steps shown in flowchart 1700 do not necessarily have to occur in the order shown. The interface may be, for example, IM interface 142.

In step 1702, interface 1506 receives a transaction request from client 1502 via server 1504. The request may be received in a messaging format/protocol that is supported by client 1502, for example, an XMPP or SMS format. The interface may be IM interface 142, the server may be IM server 160 and the client may be IM client 112.

In step 1704, interface 1506 translates the request into an intermediate format/protocol (e.g. ATOT) for intermediary server 1508 and sends it to intermediary server 1508. In an embodiment, the intermediary server may be, for example, instant money server 140.

In step 1706, interface 1506 receives a confirmation request from intermediary server 1508 in the intermediate format/protocol. Interface 1506 translates the received request from the intermediate format/protocol into a format/protocol supported by client 1502 (e.g. XMPP/SMS) and sends it to client 1502 via the server 1504.

In step 1708, interface 1506 receives a response to the confirmation request from client 1502 via the server 1504. The response may be in a format/protocol supported by client 1502, for example, an XMPP or SMS format. Interface 1506 translates the response from the client 1502 format into the intermediate format/protocol and sends it to intermediary server 1508.

In step 1710, interface 1506 receives a notification from intermediary server 1508 in the intermediate format/protocol (e.g. ATOT). The notification may be an acknowledgement of cancellation of the transaction or of success in the transaction. If there was a failure in the transaction, then the notification may include a reason for failure of the transaction, for example insufficient funds required for a funds transfer request. The notification is formatted from the intermediate format/protocol into a client 1502 supported format/protocol (e.g. XMPP/SMS) and sent to client 1502 via server 1504.

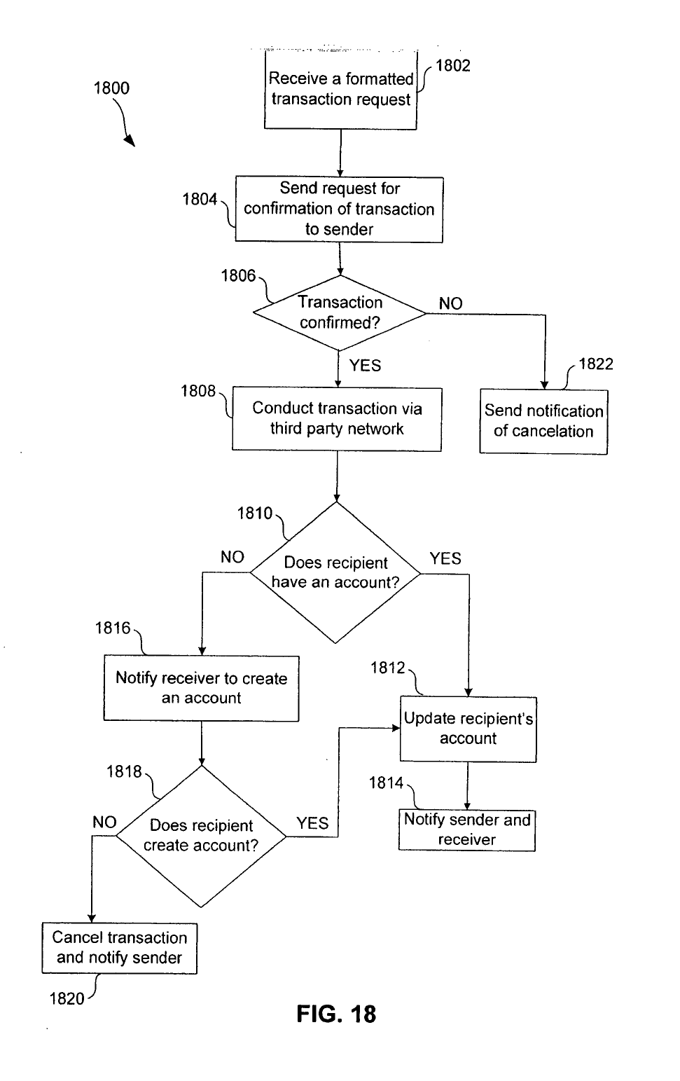

FIG. 18 illustrates an example flowchart 1800 of a method for facilitating transactions from the perspective of intermediary server 1508, according to an embodiment of the invention. Flowchart 1800 will be described with continued reference to the example operating environment depicted in FIGS. 15A and 15B. However, the flowchart is not limited to that embodiment. Note that some steps shown in flowchart 1800 do not necessarily have to occur in the order shown. The intermediary server may be, for example, instant money server 140.

In step 1802, intermediary server 1508 receives a transaction request from interface 1506. The transaction request may originate due to user input at a client 1502 and be communicated via server 1504 to interface 1506. The transaction request may originate from client 1502 in a client supported messaging format/protocol (e.g. XMPP/SMS) and may be formatted and sent by interface 1506 to intermediary server 1508 in an intermediate format/protocol (e.g. ATOT).

In step 1804, intermediary server 1508 sends a request for confirmation of the transaction to interface 1506.

In step 1806, intermediary server 1508 receives a response from interface 1506 to the confirmation request from step 1804 and determines whether the transaction has been confirmed. If the transaction is confirmed, operation proceeds to steps 1808. If the transaction is not confirmed, operation proceeds to step 1822.

In step 1808, if the transaction is confirmed in step 1806, intermediary server 1508 conducts the transaction by negotiating with a third party network 1510. The third party network may be, for example, banking networking 190 and the transaction request may be a financial transaction request. If the financial transaction request is for funds transfer by the user, then the requested amount to be transferred is withdrawn from the user's bank account.

In step 1810, intermediary server 1508 determines if the recipient has an account on intermediary server 1508. If recipient has an account, operation proceeds to step 1812. If recipient does not have an account, operation proceeds to step 1814.

In step 1812, if it is determined that the recipient has an account on intermediary server 1508, then intermediary server 1508 updates the recipient's account information with the transaction. For example, if the transaction request is for a funds transfer, then the funds are transferred to the recipient's account. If the transaction request is for a service, e.g. a maid service, then the recipient or person hired is notified of the appointment date/time. Alternatively, if the transaction is for shopping, then the recipient or merchant is notified of the purchase.

In step 1814, the sender or initiator of the request in step 1802 is notified that the transaction has been completed.

In step 1816, if it is determined that the recipient does not have an account, intermediary server 1508 notifies the recipient that an account must be created. The notification may be sent via SMS, IM, an automated or personal phone call or via e-mail.

In step 1818, a determination is made whether the recipient created an account within a set period of time. For example, a recipient may be given a week to create an account. If the recipient creates an account within the set period of time, control is transferred to step 1812. The period of time may be a design parameter programmed into intermediary server 1508.

In step 1820, if it is determined that the recipient did not create an account within the set period of time, then the transaction is canceled and a notification is sent to the sender. If the transaction request was, for example, a funds transfer request, then the amount withdrawn from the sender's account is refunded and the sender is notified of the refund.

In step 1822, if the transaction is canceled in step 1806, intermediary server 1508 sends a notification of cancellation of the transaction request from step 1806 to interface 1506.

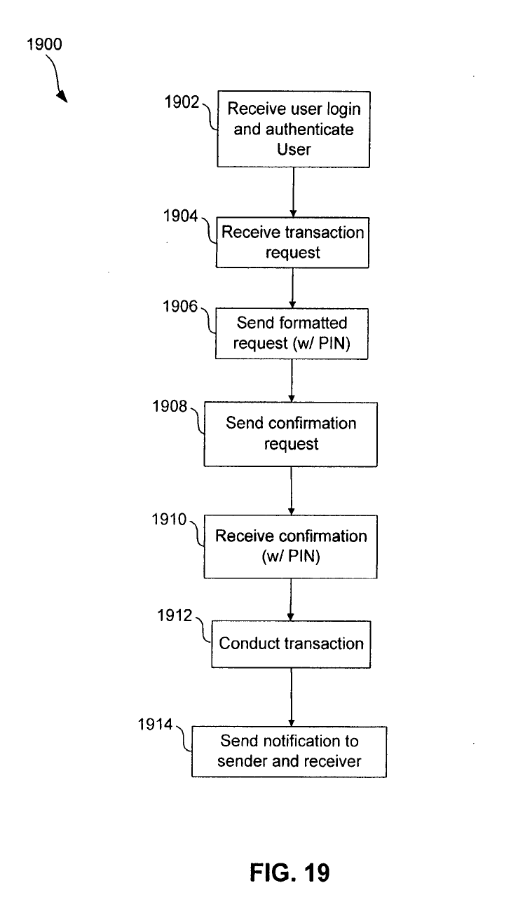

FIG. 19 illustrates an example flowchart 1900 of a method for initiating and facilitating transactions, according to an embodiment of the invention. However, the flowchart is not limited to that embodiment. Note that some steps shown in flowchart 1900 do not necessarily have to occur in the order shown.

In step 1902, a sender's login/password is received and authenticated. The sender may enter the login/password via, for example, a GUI. The client may be, for example, IM client 112 and IM server 160 authenticates the login/password.

In step 1904, a transaction request is received. The transaction request may be entered by a user via, for example, a GUI, with the client being IM client 112. The transaction request is sent to interface 1506 via server 1504. In an embodiment, the request may include a sender specific PIN entered by the sender. The transaction request from IM client 112 is sent in a messaging protocol/format supported by client 1502 (e.g. XMPP/SMS) to IM server 160 which passes the request onto IM interface 142 in the same format/protocol.

In step 1906, the interface formats the request received from the client the client specific format/protocol into an intermediate format/protocol (e.g. ATOT) and sends it to an intermediary server 1508.

Intermediary server 1508 may be instant money server 140. IM interface 142 formats the request received in XMPP into an ATOT format/protocol and sends it to instant money server 140.

In step 1908, intermediary server 1508 sends a confirmation request to interface 1506 in an intermediate format/protocol (e.g. ATOT). Interface 1506 converts the request from the intermediate format/protocol into the client specific messaging format/protocol (e.g. XMPP/SMS) and sends it to the client 1502 via the server 1504.

In step 1910, the sender responds to the confirmation request from step 1908 by using client 1502. The confirmation is formatted from a client specific messaging format/protocol (e.g. XMPP) and sent to interface 1506 via server 1504. Interface 1506 formats the request into an intermediate format/protocol (e.g. ATOT) and sends the request to intermediary server 1508. In an embodiment, the sender enters a PIN that is included with the response.

In step 1912, intermediary server 1508 conducts the transaction requested in step 1904 by communicating with a third party network 1510. The third party network may be, for example, banking network 190.

In step 1914, intermediary server 1508 sends notification of completion of transaction to the sender of the request. The notification of completion is also sent to a receiver, if there is one. As described above, the notification to the sender and receiver may be sent via the same or different means of communication. For example, the notification to sender may be sent via instant message and the notification to the recipient may be sent via SMS. The notification is received by interface 1506 in an intermediary format (e.g. ATOT) and is formatted into the appropriate client 1502 supported format/protocol by interface 1506. For example, if the sender is to be notified via instant message, then interface 1506 translates the notification into an instant messaging protocol/format (e.g. XMPP). If the receiver is to be notified via SMS, then interface 1506 translates the notification into an SMS protocol/format.

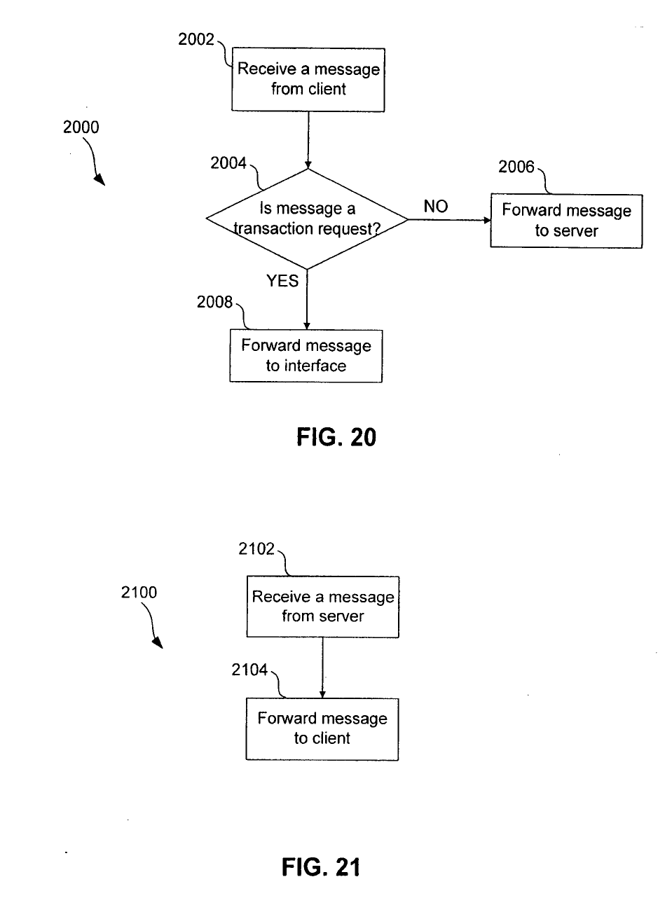

FIG. 20 illustrates an example flowchart 2000 of a method for receiving and processing client originated messages from the perspective of proxy 1532 according to an embodiment of the invention. Flowchart 2000 will be described with continued reference to the example operating environment depicted in FIG. 15C. However, the flowchart is not limited to that embodiment. Note that some steps shown in flowchart 2000 do not necessarily have to occur in the order shown.

In step 2002, proxy 1532 receives a message from client 1502 in an instant messaging format.

In step 2004, proxy 1532 determines whether the message received in step 2002 is a transaction request. Proxy 1532 identifies transaction requests by parsing messages for keywords, syntax, semantics etc. as described above.

In step 2006, if the message determined to not be a transaction request in step 2004, proxy 1532 forwards the message to server 1504 without further processing.

In step 2008, if the message is determined to be a transaction request in step 2004, proxy 1532 forwards the message to interface 1506. In an alternate embodiment, proxy 1532 translates the message from the instant messaging protocol in use into a text over internet protocol before forwarding the message to interface 1506.

FIG. 21 illustrates an example flowchart 2100 of a method for receiving and processing server originated messages from the perspective of proxy 1532 according to an embodiment of the invention. Flowchart 2100 will be described with continued reference to the example operating environment depicted in FIG. 15C. However, the flowchart is not limited to that embodiment. Note that some steps shown in flowchart 2100 do not necessarily have to occur in the order shown.

In step 2102, proxy 1532 receives a message from server 1504 in an instant messaging format.

In step 2104, proxy 1532 forwards the message received from server 1504 to client 1502. In an alternate embodiment, if the message received from server 1504 is not in an instant messaging format, proxy 1532 translates the message into an instant messaging format compatible with client 1502 before forwarding the message to client 1502.

The present invention, or portions thereof, can be implemented in hardware, firmware, software, and/or combinations thereof.

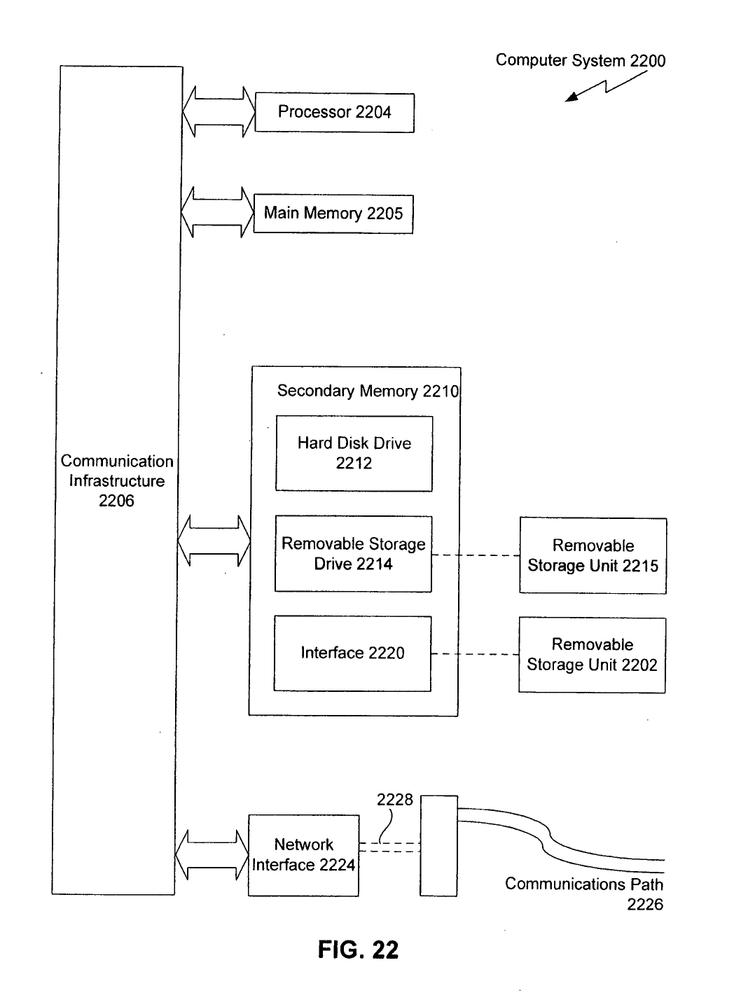

The following description of a general purpose computer system is provided for completeness. The present invention can be implemented in hardware, or as a combination of software and hardware. Consequently, the invention may be implemented in the environment of a computer system or other processing system. An example of such a computer system 2200 is shown in FIG. 22. The computer system 2200 includes one or more processors, such as processor 2204. Processor 2204 can be a special purpose or a general purpose digital signal processor. The processor 2204 is connected to a communication infrastructure 2206 (for example, a bus or network). Various software implementations are described in terms of this exemplary computer system. After reading this description, it will become apparent to a person skilled in the relevant art how to implement the invention using other computer systems and/or computer architectures.

Computer system 2200 also includes a main memory 2205, preferably random access memory (RAM), and may also include a secondary memory 2210. The secondary memory 2210 may include, for example, a hard disk drive 2212, and/or a RAID array 2216, and/or a removable storage drive 2214, representing a floppy disk drive, a magnetic tape drive, an optical disk drive, etc. The removable storage drive 2214 reads from and/or writes to a removable storage unit 2218 in a well known manner. Removable storage unit 2218, represents a floppy disk, magnetic tape, optical disk, etc. As will be appreciated, the removable storage unit 2218 includes a computer usable storage medium having stored therein computer software and/or data.

In alternative implementations, secondary memory 2210 may include other similar means for allowing computer programs or other instructions to be loaded into computer system 2200. Such means may include, for example, a removable storage unit 2222 and an interface 2220. Examples of such means may include a program cartridge and cartridge interface (such as that found in video game devices), a removable memory chip (such as an EPROM, or PROM) and associated socket, and other removable storage units 2222 and interfaces 2220 which allow software and data to be transferred from the removable storage unit 2222 to computer system 2200.

Computer system 2200 may also include a communications interface 2224. Communications interface 2224 allows software and data to be transferred between computer system 2200 and external devices. Examples of communications interface 2224 may include a modem, a network interface (such as an Ethernet card), a communications port, a PCMCIA slot and card, etc. Software and data transferred via communications interface 2224 are in the form of signals 2228 which may be electronic, electromagnetic, optical or other signals capable of being received by communications interface 2224. These signals 2228 are provided to communications interface 2224 via a communications path 2226. Communications path 2226 carries signals 2228 and may be implemented using wire or cable, fiber optics, a phone line, a cellular phone link, an RF link and other communications channels.

The terms “computer program medium” and “computer usable medium” are used herein to generally refer to media such as removable storage drive 2214, a hard disk installed in hard disk drive 2212, and signals 2228. These computer program products are means for providing software to computer system 2200.

Computer programs (also called computer control logic) are stored in main memory 2208 and/or secondary memory 2210. Computer programs may also be received via communications interface 2224. Such computer programs, when executed, enable the computer system 2200 to implement the present invention as discussed herein. In particular, the computer programs, when executed, enable the processor 2204 to implement the processes of the present invention. Where the invention is implemented using software, the software may be stored in a computer program product and loaded into computer system 2200 using raid array 2216, removable storage drive 2214, hard drive 2212 or communications interface 2224.

In other embodiments, features of the invention are implemented primarily in hardware using, for example, hardware components such as Application Specific Integrated Circuits (ASICs) and gate arrays. Implementation of a hardware state machine so as to perform the functions described herein will also be apparent to persons skilled in the relevant art(s).

Embodiments of the invention may be implemented in hardware, firmware, software, or any combination thereof. Embodiments of the invention may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact result from computing devices, processors, controllers, or other devices executing the firmware, software, routines, instructions, etc

### 4.0 CONCLUSION

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A method for processing a transaction initiated using a messaging client, comprising:
receiving a request in an intermediate protocol identifying a recipient and including transaction information, wherein the request originates from the messaging client in a messaging protocol supported by the messaging client and is translated into the intermediate protocol by an interface;
sending a confirmation request to the messaging client, via the interface, wherein the confirmation request includes a request for confirmation of the requested transaction and wherein the confirmation request is translated by the interface from the intermediate protocol into the messaging protocol supported by the client;
facilitating the requested transaction in response to a confirmation of the requested transaction; and
sending notification of completion of the requested transaction to the messaging client, via the interface, wherein the notification is translated by the interface from the intermediate protocol to the messaging protocol supported by the messaging client.

2. The method of claim 1, further comprising determining whether the recipient has an account.

3. The method of claim 2, further comprising notifying the recipient that an account must be created prior to completion of the transaction.

4. The method of claim 1, wherein the messaging protocol is an instant messaging protocol.

5. The method of claim 1, wherein the intermediary protocol is encoded text over internet protocol.

6. The method of claim 1, wherein the intermediary protocol is Unicode text over internet protocol.

7. The method of claim 1, wherein the receiving a request and sending confirmation steps are performed via an instant messaging protocol and the sending notification step is performed via e-mail.

8. The method of claim 1, wherein the receiving request and sending confirmation steps are performed via a Short Message Service (SMS) messaging protocol and the sending notification step is performed via electronic mail (e-mail).

9. The method of claim 1, wherein the messaging client is one of an instant messaging client or a Short Message Service (SMS) client.

10. The method of claim 1, wherein the messaging client includes one of a buddy list or a contact list.

11. The method of claim 1, wherein the messaging client is an instant messaging client, the messaging protocol is an EXtensible Messaging and Presence Protocol (XMPP) and the intermediate protocol is an American Standard Code for Information Interchange (ASCII) Text Over Transmission Control Protocol/Internet Protocol (TCPIP).

12. The method of claim 1, wherein the messaging client is a Short Message Service (SMS) client, the messaging protocol is an SMS protocol and the intermediate protocol is an American Standard Code for Information Interchange (ASCII) Text Over Transmission Control Protocol/Internet Protocol (TCPIP).

13. The method of claim 1, the facilitating step further comprising interacting with a third party network to facilitate the transaction.

14. The method of claim 1, wherein the transaction is a financial transaction and includes a transfer of funds from a source account to a destination account.

15. The method of claim 14, wherein the financial transaction is one of a loan transaction, bill transaction, a voucher transaction or a tax payment transaction.

16. The method of claim 14, wherein the source and destination accounts include one or more of a bill pay sub-account, loan sub-account, voucher sub-account and tax sub-account.

17. A method to initiate a financial transaction using a messaging client, comprising:
receiving a financial transaction request, wherein the financial transaction request identifies a recipient and an amount of a transaction;
formatting the financial transaction request using the messaging client into a first format according to a messaging protocol and sending the formatted financial transaction request;
receiving a confirmation request for the financial transaction in the first format;
formatting the confirmation request using the messaging client into a Graphical User Interface (GUI) format and displaying the confirmation request;
receiving input corresponding to the confirmation request via the messaging client;
formatting the received input into the first format using the messaging client and sending the input to the confirmation request; and
receiving and formatting a notification of completion of the transaction in the GUI format and displaying the notification.

18. The method of claim 17, further comprising connecting to a server.

19. The method of claim 18, further comprising, receiving user identification information via a GUI, formatting user identification information into the first format and sending the formatted user identification information to the server for authentication.

20. The method of claim 17, wherein the messaging client is an instant messaging client and the first format is based on an EXtensible Messaging and Presence Protocol (XMPP).

21. The method of claim 17, wherein the messaging client is a Short Message Service (SMS) client and the first format is based on a Short Message Service (SMS) protocol.

22. A method to facilitate a transaction initiated using a messaging client, comprising:
receiving a transaction request in a first format according to a messaging protocol from the messaging client;
formatting the transaction request into a second format and sending the formatted request to an intermediary server;
receiving a notification of completion of transaction from the intermediary server in the second format;
formatting the notification in the first format and sending the formatted notification to the messaging client.

23. The method of claim 22, wherein the first format is based on an EXtensible Messaging and Presence Protocol (XMPP).

24. The method of claim 22, wherein the first format is based on a Short Message Service (SMS) protocol.

25. The method of claim 22, wherein the second format is an American Standard Code for Information Interchange (ASCII) Text Over Transmission Control Protocol/Internet Protocol (TCPIP) format.

26. The method of claim 22, further comprising receiving a confirmation request from the intermediary server in the second format.

27. The method of claim 26, further comprising formatting and sending the confirmation request to the messaging client in the first format.

28. The method of claim 27, further comprising receiving a response to the confirmation request from the client in the first format.

29. The method of claim 28, further comprising formatting and sending the confirmation request to the intermediary server in the second format.

30. A method to facilitate a transaction initiated using a messaging client, comprising:
receiving a message in a first format according to a messaging protocol from the messaging client;
determining whether the message is a transaction request; and
formatting the message into a second format, if the message is a transaction request, and sending the formatted request to an interface.

31. The method of claim 30, wherein the first format is an instant messaging protocol and the second format is encoded text over internet protocol.

32. The method of claim 30, further comprising receiving a message from a server in the first format and forwarding the message to the messaging client.

33. The method of claim 30, further comprising receiving a message from a server in the second format, formatting the message into the first format and forwarding the message to the messaging client.
